(19) United States
(12) Patent Application Publication
(10) Pub. No.: US 2005/0111123 A1
(43) Pub. Date: May 26, 2005

(54) Master information carrier and method of manufacturing the same, method of recording master information signal on magnetic recording medium, method of manufacturing the magnetic recording medium, and magnetic recording and reproducing apparatus

(75) Inventors: Masaya Sakaguchi, Osaka (JP); Tatsuaki Ishida, Otsu-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 10/989,343

(22) Filed: Nov. 17, 2004

(30) Foreign Application Priority Data
Nov. 20, 2003 (JP) 2003-390512
Jan. 14, 2004 (JP) 2004-6559

(51) Int. Cl. G11B 5/86; G11B 5/02

(52) U.S. Cl. 360/16; 360/59

(57) ABSTRACT

On a translucent non-magnetic substrate, a master information carrier having an information signal pattern made of light-proof ferromagnetic thin-film is prepared, and a magnetic recording medium having undergone DC erasing is placed opposite to the carrier. The carrier in the foregoing state is irradiated with light while a bias magnetic field having a reverse polarity to the DC erasing magnetic field is applied to the medium. As a result, a magnetized pattern corresponding to the information signal array can be transcribed and recorded on the medium. In the case of using a magnetic recording medium having so great coercive force that a transcribing and recording magnetic field is not enough to work on this medium, the foregoing structure allows transcribing and recording a signal having excellent performance because a section having undergone the light irradiation lowers the coercive force.

### FIELD OF THE INVENTION

The present invention relates to a master information carrier to be used for recording digital information signals on a magnetic recording medium and a method of manufacturing the carrier. It also relates to a method of recording master information signal on a magnetic recording medium, method of manufacturing the magnetic recording media, and a magnetic recording and reproducing apparatus.

### BACKGROUND OF THE INVENTION

A magnetic reading and reproducing apparatus has increased its recording density to achieve a smaller size and a larger capacity. A hard disc drive (HDD) as a typical magnetic recording and reproducing apparatus, in particular, achieves an areal recording density of more than 60 Gbit/in² (93 Mbit/mm²) and is available on the market. Now an areal recording density of 100 Gbit/in² (155 Mbit/mm²) are practically discussed. As such, drastic technical advancement is expected in this field.

One of the primary technical factors that have allowed such a high recording density is the increasing of linear recording density. This increase is achieved by improvements of medium properties and a head-disc interface performance, and availability of novel signal processing methods such as partial response. However, the rate of increase in track density recently exceeds considerably that of linear recording density, and thus becomes a primary factor of increasing the areal recording density. Practical use of a thin-film magnetic head employs magneto-resistive elements (MR element) or giant magneto-resistive elements (GMR element), i.e. MR head or GMR head, which are superior to a conventional inductive head in reproduction output performance, has contributed to the progress in the track density. It is possible at present to reproduce a signal from a track as narrow as not wider than one micron with a high SIN ratio by practical use of the GMR head. The head performance will be further improved, which entails the narrower track pitch such as a sub-micron order.

A tracking servo technique is important for the head to read a signal with a high SIN ratio by scanning accurately such a narrow track. The following tracking servo technique goes a main stream in the present HDD: A hard disc has areas that are located at given angular intervals on the disc over 360°, and information such as a tracking servo signal, address signal and a read clock signal are recorded in the areas (hereinafter the information is referred to as “preformat information, and recording such preformat information is referred to as “preformat recording”). A magnetic head reads such information at given periods, thereby monitoring and correcting the head position if deviation occurs. This mechanism allows the magnetic head to scan accurately a given track.

The foregoing tracking servo signal, address and read clock signal are to be reference signals for the head to scan a track accurately. Precise positioning is thus required for recording those information signals on the disc surface. The format is recorded on a hard disc with magnetic heads precisely positioned under the control of a dedicated servo-track recording apparatus after installing the disc into the drive. The foregoing preformat recording, however, has some problems as follows:

The first problem is caused by the fact that the relative movement between the head and the medium is necessary, in general, for recording with the magnetic head. This method takes a long time for the preformat recording, on top of that, the dedicated servo-track recording apparatus is expensive. As a result, the preformat recording on a magnetic medium becomes quite expensive.

The second problem is a lack of steep in magnetic transition at track edges where the preformat is recorded. This lack of steep is caused by a space between the head and a medium or diffusion of recording magnetic field due to a pole shape of the head.

The present tracking servo technique allows detecting the head position by an amount of a change in an amplitude of a read signal when the head misses a track. The signal track, where the preformat information is recorded, thus needs not only an excellent SIN ratio at accurate scanning by the head on a track and at reading data signals by the head, but also steep off-track performance, namely, an explicit change in a read-signal output when the magnetic head misses the track. The lack of steep of magnetic transition at the track edges makes it difficult to achieve an accurate tracking servo technique that is needed for recording a signal on a track on a sub-micron order.

To overcome the problems discussed above, a method is disclosed in Japanese Patent Application Non-Examined Publication No. H10-40544. This method (hereinafter referred to as “prior art 1”) adopts a master information carrier having a ferromagnetic thin-film pattern formed on the substrate surface of the carrier, and the pattern corresponds to an information signal. The surface of this carrier is brought into contact with the surface of the magnetic recording medium of which any patterns have been erased by applying a DC in advance. Then a DC bias magnetic field, having a reversed polarity to the polarity at the DC initialization, is applied to the surface of the carrier. As a result, the magnetized pattern corresponding to the ferromagnetic thin-film pattern on the surface of the master information carrier can be recorded in a lump-sum manner on the magnetic recording medium. In other words, the preformat can be recorded by this areal lump-sum recording method.

FIGS. 27A-27C illustrate a conventional method of recording a preformat, and this method is disclosed in prior art 1. FIG. 27A shows a state where a DC erasing magnetic field is applied to magnetic recording layer 30.

This application allows magnetizing direction 32 in layer 30 to go along the same direction of DC erasing magnetic field 31.

FIG. 27B shows a state where magnetic recording layer 30 of the magnetic recording medium confronts master information carrier 101, and DC bias magnetic filed 5 reverse to the initialized magnetization by the DC erasing is applied. Master information carrier 101 has ferromagnetic thin-film 103 having a given pattern and formed on its nonmagnetic substrate 101. FIG. 27B does not show the entire magnetic recording medium, but shows only magnetic recording layer 30. Hereinafter thus any drawing illustrating only layer 30 can be referred to as a magnetic recording medium. Magnetic flux lines 102 in this state concentrate on ferromagnetic thin-film 103, and diverges in the other sections. The magnetic field applied to magnetic recording layer 30 opposing to ferromagnetic thin-film 103 becomes weak. The magnetic field applied to the sections other than ferromagnetic thin-film 103 becomes strong, so that magnetization 104 at these sections is reversed and goes along the direction of DC bias magnetic field 5.

FIG. 27C shows a magnetized state in magnetic recording layer 30 after the preformat recording. The method discussed above allows transcribing and recording the magnetized pattern corresponding to the pattern on ferromagnetic thin-film 103 onto the magnetic recording medium. To be more specific, the pattern corresponding to a tracking servo signal, an address information signal, and a clock signal in ferromagnetic thin-film 103 is formed on the master information carrier by a photolithography method, so that the preformat corresponding to this pattern can be recorded on the magnetic recording medium in a lump-sum manner.

The conventional linear recording is primarily a dynamic linear recording based on relative movement between the head and the medium. On the other hand, the foregoing method employs a static and areal lump-sum recording with the master information carrier brought into contact with the magnetic recording medium, so that this method does not need the relative movement. The recording method of prior art 1 has the following advantages over the conventional preformat recording method:

First, since the areal recording (areal lump-sum recording) is carried out, a time necessary for the preformat recording becomes considerably shorter than that of the conventional method using a magnetic head. On top of that, the expensive dedicated servo-track recording apparatus for controlling accurately a head position is not needed. As a result, this method can substantially improve the productivity of the preformat recording and reduce the production cost.

Second, the areal recording, i.e. a static recording free from relative movement between the master information carrier and the magnetic recording medium, allows minimizing the space between the carrier and the medium in recording by the solid contact between the surface of the carrier and the surface of the medium. Further, unlike the prior art using a magnetic head, a diffusive recording magnetic field caused by a pole shape of the magnetic head does not occur. As a result, the magnetic transition at track edges where the preformat is recorded becomes steeper than the conventional recording using a magnetic head. The more accurate tracking can be thus expected.

However, use of the preformat recording method disclosed in prior art 1 encounters difficulty in working on a magnetic recording medium having high coercive force, this high coercive force will be necessary for the higher density recording expected in the near future. For this method to work on the magnetic recording medium having the high coercive force, it is necessary to increase the magnetic field generated from the ferromagnetic thin-film pattern formed on the surface of the master information carrier. To achieve this increase, the following three methods are conceivable. (1) increase a DC bias magnetic field, (2) increase a density of saturated magnetic flux of ferromagnetic thin-film material, and (3) increase a thickness of the ferromagnetic thin-film.

FIG. 28 shows a relation between a magnetic field applied to a magnetic recording layer (not shown) and a position of master information carrier 101 when a DC bias magnetic field changes. This magnetic recording layer is identical to magnetic recording layer 30 shown in FIG. 27A. In the following discussion, layer 30 is used for the description purpose. In FIG. 28, the vertical axis represents the magnetic field applied to layer 30, and the lateral axis represents a position of master information carrier 101. As shown in FIG. 28, the magnetic field applied to layer 30 increases as the DC bias magnetic field increases. However, this increase adversely affects some region which wants to avoid the magnetic field, i.e. the region opposing to ferromagnetic thin-film 103 receives the magnetic field increased. This region retains the magnetized direction obtained when layer 30 has undergone the DC erasing. This phenomenon occurs due to saturation of magnetization of ferromagnetic thin-film 103. Use of foregoing method (1) to a magnetic recording medium having high coercive force thus finds difficulty in obtaining quality signals, namely, a high SIN ratio.

Use of method (2) or (3) can suppress the unnecessary magnetic field produced due to the saturation of magnetization of ferromagnetic thin-film 103, thereby increasing only the necessary magnetic field. However, use of method (2) encounters material limitation and requires improvement in anticorrosion of the materials. Use of method (3) is obliged to handle ferromagnetic thin-film 103 having an increased aspect ratio, so that it is difficult to produce the shape of thin-film 103 accurately and steadily by photolithography or etching method. Therefore, it is not so easy for method (3) to increase dramatically the magnetic field generated from thin-film 103.

Based on the foregoing discussion, it can be concluded that the method disclosed in prior art 1 finds it difficult to achieve a quality preformat recording with a magnetic recording medium having high coercive force that will be necessary for the higher density recording.

In view of the problems discussed above, a novel recording technique that satisfies the following three points is demanded: (a) excellent productivity, (b) steep magnetic transition, and (c) workable on a magnetic recording medium having high coercive force.

The present invention aims to achieve the foregoing targets, namely, the present invention aims to provide a master information carrier featuring a productivity similar to that of the lump-sum recording method, steep magnetic transition, and performing quality recording on a magnetic recording medium having high coercive force. The present invention also aims to provide a method of manufacturing the master information carrier, a method of recording signals of master information on a magnetic recording medium, a method of manufacturing the magnetic recording media, and a magnetic recording and reproducing apparatus using the magnetic recording medium.

### SUMMARY OF THE INVENTION

A master information carrier of the present invention comprises the following elements:
a non-magnetic substrate having at least translucency; and
a ferromagnetic thin-film having translucency, being patterned corresponding to an information signal array, and formed on the non-magnetic substrate.

A method of manufacturing the master information carrier comprises the following steps:
forming a resist pattern in response to an information signal array on a non-magnetic substrate having at least translucency;
etching the non-magnetic substrate at a region where the resist pattern does not exist for forming a groove;
forming a light-proof ferromagnetic thin-film on the non-magnetic substrate including the resist pattern; and
removing the ferromagnetic thin-film on the resist pattern at the time when the resist pattern is removed.

A recording method of the present invention onto a magnetic recording medium is to record a magnetized pattern corresponding to an information signal array onto the magnetic recording medium, the method comprises the following steps:
placing a master information carrier opposing to a surface of the magnetic recording medium, the master information carrier having a pattern made of ferromagnetic thin-film and corresponding to the information signal array and formed on the non-magnetic substrate; and
heating, via the master information carrier, the surface of the magnetic recording medium at a local place opposing to a region between the ferromagnetic thin-films adjacent to each other formed on the master information carrier while a bias magnetic field is applied at least to a magnetic recording layer of the medium and the ferromagnetic thin-film of the carrier.

In the foregoing recording method, the non-magnetic substrate can have translucency, and the local heating to the surface of the medium can be done by irradiating the surface with light energy transmitted via the region between the light-proof ferromagnetic thin-films adjacent to each other of the carrier. There is another way; the master information carrier can have a projection protruding from the region between the ferromagnetic thin-films adjacent to each other, and heat energy due to the local heating can be conveyed via the projection to the magnetic recording medium.

For instance, in the case of irradiating the surface with light energy for heating, the following method is available. Place the master information carrier of the present invention opposing to the surface of the magnetic recording medium having undergone the DC erasing. Then apply a bias magnetic field having a polarity reverse to an initial magnetization done by the DC erasing. In this status, irradiate the medium with light from the opposite side of the medium with respect to the carrier.

The light irradiation is blocked at sections where the ferromagnetic thin-films exist; however, the light travels through the other sections of the carrier where no ferromagnetic thin-film exist, and reaches the surface of the medium, then heat there locally. The local place heated is an irradiated section. At the irradiated section of the medium, light energy is transduced into thermal energy, so that the temperature of the irradiated section rises locally. The coercive force of the magnetic recording layer changes as the temperature rises. For instance, around the Curie temperature where the magnetization of the recording layer disappears, the coercive force lowers almost to zero (0). In other words, irradiation of light can lower the coercive force of the irradiated section. This irradiated section lowering the coercive force is a place where the magnetization having undergone the DC erasing is expectedly to be reversely recorded by the magnetic field generated from the ferromagnetic thin-film when the bias magnetic field is applied.

The mechanism discussed above allows transcribing and recording the master information signals on the magnetic recording medium even if the ferromagnetic thin-film of the master information carrier generates a weak magnetic field. In other words, the master information signals are recorded on the medium with coercive force lowered, so that the signals can be recorded in good condition on the magnetic recording medium of which coercive force was originally strengthened to meet the higher density recording.

A method of manufacturing the magnetic recording media of the present invention includes a process of recording a magnetized pattern corresponding to an information signal array onto the magnetic recording medium, and the method comprising the steps of:
forming at least one magnetic recording layer and at least one protective layer on a plate;
forming a lubricating layer on the protective layer;
placing the master information carrier with its ferromagnetic thin-film opposing to the magnetic recording layer formed on the plate, the carrier having a pattern, made of ferromagnetic thin-film and corresponding to the information signal array on the non-magnetic substrate; and
applying a bias magnetic field at least to the magnetic recording layer and the ferromagnetic thin-film of the carrier, and heating the magnetic recording layer locally at a section opposing to a region between the ferromagnetic thin-films adjacent to each other of the carrier, thereby recording a magnetized pattern corresponding to the information signal array onto the magnetic recording layer.

In the foregoing manufacturing method, the non-magnetic substrate can have translucency, and the local heating to the surface of the medium can be done by irradiating the surface with light energy transmitted via the region between the light-proof ferromagnetic thin-films adjacent to each other on the carrier. There is another way; the master information carrier can have a projection protruding from the region between the ferromagnetic thin-films adjacent to each other, and the thermal energy of the local heating can be conveyed via the projection to the magnetic recording medium.

A magnetic recording and reproducing apparatus of the present invention comprises the following elements:
a thin-film magnetic head;
a magnetic recording medium recorded a magnetized pattern corresponding to an information signal array on a magnetic recording layer by placing the master information carrier with its ferromagnetic thin-film opposing to the magnetic recording layer formed on the magnetic recording medium, the carrier having a pattern made of ferromagnetic thin-film and corresponding to the information signal array on the non-magnetic substrate, and heating the surface of the medium locally at a section opposing to the region between the ferromagnetic thin-films adjacent to each other of the carrier while applying a bias magnetic field at least to the magnetic recording layer of the medium and the ferromagnetic thin-film of the carrier;
a supporting member for supporting the thin-film magnetic head such that the head opposes to the magnetic recording medium;
a rotating device for rotating the magnetic recording medium;
an actuating device coupled to the supporting member and moving the thin-film magnetic head along a film surface of the magnetic recording medium; and
a processing section coupled electrically to the thin-film magnetic head, the rotating device, and the actuating device, for exchanging a signal with the head, controlling the rotating of the medium, and controlling the moving of the head.

The structure discussed above allows providing a magnetic recording and reproducing apparatus featuring an excellent productivity and quality signals by preformat recording even if the magnetic recording medium having high coercive force needed for the higher density recording is used.

As discussed above, the present invention provides the master information carrier, the method of recording the master information signal on the magnetic recording medium, the method of manufacturing the magnetic recording media, and the magnetic recording and reproducing apparatus. According to the present invention, even if the magnetic recording medium having high coercive force needed for the higher density recording is used, the magnetic recording and reproducing apparatus featuring an excellent productivity and quality signals by preformat recording is obtainable. This apparatus can deal with the higher density recording with ease, and the cost thereof can be inexpensive.

The magnetic recording media of the present invention can be used as a magnetic disc mounted to HDDs, flexible magnetic discs, magnetic cards, and magnetic tapes. A recordable signal by the present invention is not limited to an information signal for the preformat recording, but it can be applicable to the recording of such information as data, audio and video onto a magnetic recording medium.

### BRIEF DESCRIPTION OF THE DRAWINGS

FIG. 1 shows a sectional view illustrating a structure of a master information carrier in accordance with a first exemplary embodiment of the present invention.

FIG. 2 shows a sectional view illustrating the master information carrier irradiated with light in the first embodiment.

FIG. 3A and FIG. 3B show sectional views illustrating the master information carrier to which a DC bias magnetic field is applied in the first embodiment.

FIG. 4 shows a distribution of a magnetic field for transcribing and recording in accordance with the first exemplary embodiment of the present invention.

FIG. 5 shows a plan view illustrating a structure of the master information carrier in accordance with the first exemplary embodiment of the present invention.

FIG. 6 shows an enlarged plan view illustrating a structure of a pattern of an information signal array formed on the master information carrier in accordance with the first exemplary embodiment of the present invention.

FIG. 7 shows an enlarged plan view illustrating another structure of a pattern of an information signal array formed on the master information carrier in accordance with the first exemplary embodiment of the present invention.

FIG. 8A-FIG. 8D show sectional views illustrating a method of manufacturing the master information carrier in accordance with the first embodiment.

FIG. 9A-FIG. 9E show sectional views illustrating another method of manufacturing the master information carrier in accordance with the first embodiment.

FIG. 10A and FIG. 10B show sectional views illustrating another structure of the master information carrier in accordance with the first exemplary embodiment of the present invention.

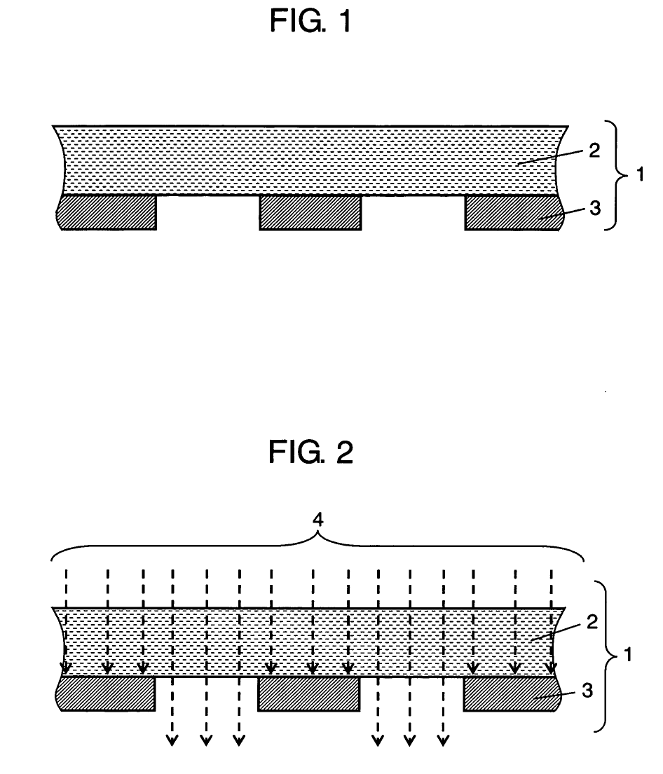

FIG. 1A-FIG. 11E show sectional views illustrating still another method of manufacturing the master information carrier in accordance with the first embodiment.

FIG. 12A-FIG. 12F show sectional views illustrating yet another method of manufacturing the master information carrier in accordance with the first embodiment.

FIG. 13A and FIG. 13B show sectional views illustrating a method of recording a master information signal onto a magnetic recording medium in accordance with a second exemplary embodiment of the present invention.

FIG. 14A and FIG. 14B show a temperature distribution and a coercive force distribution of the magnetic recording medium when the medium is irradiated with light through a master information carrier in the second embodiment.

FIG. 15 shows a distribution of coercive force and a distribution of a magnetic field for transcribing and recording of the magnetic recording medium when the medium is irradiated with light traveling through the master information carrier in the second embodiment.

FIG. 16 shows a sectional view illustrating a method of light radiation in the second embodiment.

FIG. 17 shows a sectional view illustrating another method of light radiation in the second embodiment.

FIG. 18 shows a sectional view illustrating a method of applying a magnetic field in the second embodiment.

FIG. 19 shows a relation between a wavelength for recording an information signal and a distribution of magnetic field for transcribing and recording.

FIG. 20 shows a relation between a DC bias magnetic field and the magnetic field for transcribing and recording in the second embodiment.

FIG. 21 shows a relation of a distance “d” between a ferromagnetic thin-film of the master information carrier and the magnetic recording medium vs. an effective transcribing magnetic field.

FIG. 22 shows a relation between “d/λ” and an effective transcribing magnetic field, where “d” represents a distance between a ferromagnetic thin-film of the master information carrier and the magnetic recording medium, and “λ” represents a recording wavelength of an information signal in the second embodiment.

FIG. 23 shows another relation between “d/λ” and the effective transcribing magnetic field in the second embodiment.

FIG. 24 shows still another relation between “d/λ” and an effective transcribing magnetic field that is normalized by the maximum value thereof in the second embodiment.

FIG. 25 shows a sectional view illustrating a construction of a magnetic recording and reproducing apparatus in accordance with a third exemplary embodiment of the present invention.

FIG. 26 shows a sectional view illustrating another master information carrier of the present invention, which carrier has projections protruding from regions between ferromagnetic thin-films adjacent to each other.

FIG. 27A-FIG. 27C show sectional views illustrating a conventional method of recording a master information signal on a magnetic recording medium.

FIG. 28 shows a relation between a DC bias magnetic field and a magnetic field applied to the magnetic recording medium used in the conventional method of recording the master information signal on the magnetic recording medium.

### DETAILED DESCRIPTION OF EXEMPLARY EMBODIMENT

Exemplary embodiments of the present invention are demonstrated hereinafter with reference to the accompanying drawings. Similar elements to those in another drawing have the same reference marks, and the descriptions thereof are sometimes omitted.

### Exemplary Embodiment 1

FIG. 1 shows a sectional view of master information carrier 1 in accordance with the first exemplary embodiment of the present invention. Master information carrier 1 includes a pattern, made of light-proof ferromagnetic thin-film 3 and formed on translucent non-magnetic substrate 2, corresponding to an information signal array.

FIG. 2 shows a sectional view illustrating master information carrier 1 irradiated with light in this embodiment. Light 4 is irradiated along a direction vertical to the face on which light-proof ferromagnetic thin-film 3 is formed, so that light 4 can transmit through translucent non-magnetic substrate 2 but cannot transmit through ferromagnetic thin-film 3. Light 4 can thus transmit only through the regions between ferromagnetic thin-films adjacent to each other, namely, those regions are light transmittable areas.

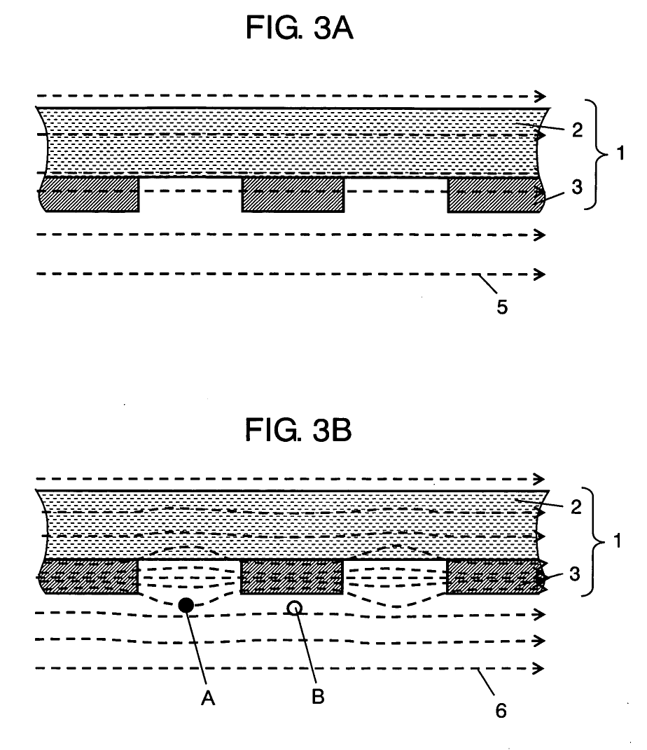

FIG. 3A and FIG. 3B show sectional view illustrating master information carrier 1 to which DC bias magnetic field 5 is applied in the first embodiment. FIG. 3A shows DC bias magnetic field 5 applied, and FIG. 3B shows magnetic flux 6 generated when magnetic field 5 is applied. DC bias magnetic field 5 is applied along a direction in parallel with the face on which light-proof ferromagnetic thin-film 3 is formed. Magnetic flux 6 generated by magnetic field 5 applied concentrates on sections where ferromagnetic thin-films 3 exist and diverges at the other sections where no ferromagnetic thin-films 3 exist.

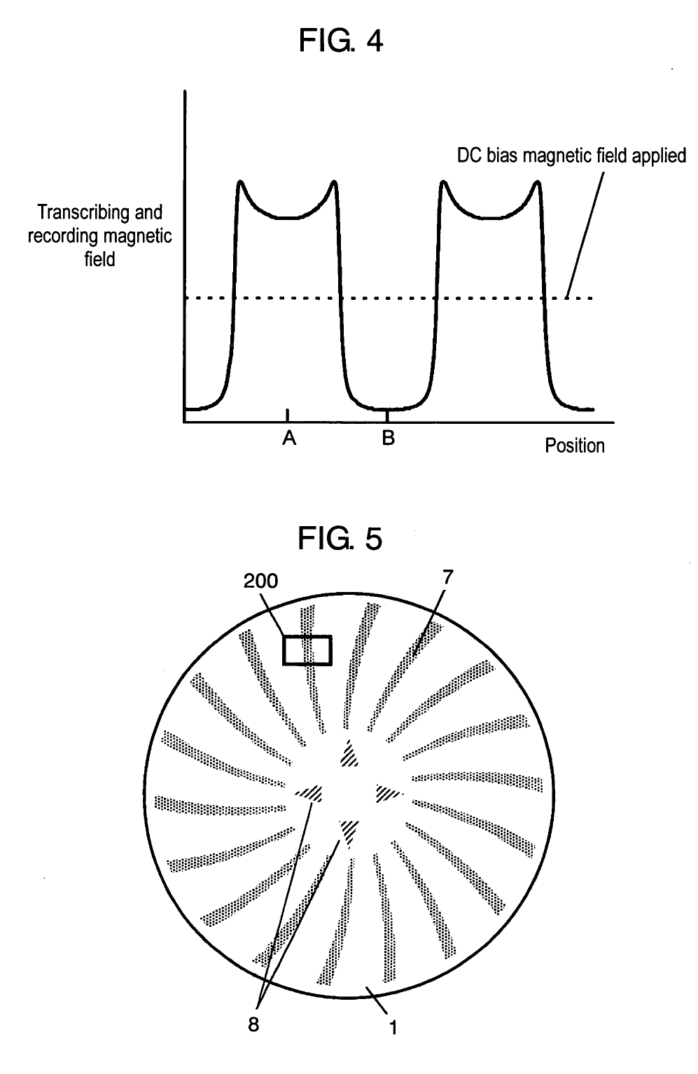

For instance, around point A in FIG. 3B, ferromagnetic thin-films 3 that collects magnetic flux 6 are available on both sides in FIG. 3. Magnetic flux 6 collected by ferromagnetic thin-film 3 on both the sides diverges around point A; however, it does not diverge wide enough because the distance between ferromagnetic thin-films on both the sides is small. As a result, a greater magnetic field than DC bias magnetic field 5 is applied to point A. On the other hand, ferromagnetic thin-film 3 that collects magnetic flux 6 exists above point B in FIG. 3B. Since magnetic flux 6 concentrates on ferromagnetic thin-film 3, little amount of flux 6 flows through point B. As a result, a smaller magnetic filed than DC bias magnetic field 5 is applied to point B. FIG. 4 shows a distribution of transcribing and recording magnetic field on the straight lines running on points A and B shown in FIG. 3B. The distribution shows a magnetic field component along the direction in parallel with the face (lateral direction with respect to FIG. 3B) on which ferromagnetic thin-film 3 of non-magnetic substrate 2 is formed. Master information carrier 1 in accordance with this embodiment has the structure discussed above. This structure has various advantages over the transcribing and recording method disclosed in prior art 1. The advantages over the method of prior art 1 are described hereinafter.

First, the transcribing and recording method disclosed in prior art 1 is described. This method uses master information carrier 101 shown in FIG. 27, and when this method generates a transcribing and recording magnetic field shown in FIG. 4, if the coercive force of magnetic recording medium is similar to the DC bias magnetic field applied, the transcribing and recording can be carried out. However, if the coercive force of magnetic recording layer 30 increases to an extent greater than a magnetic field applied to point A, the transcribing and recording cannot be done on the magnetic recording medium having such magnetic recording layer 30.

Next, a recording method using the master information carrier 1 of the present invention is demonstrated hereinafter. FIG. 2-FIG. 4 tell that use of master information carrier 1 and light irradiation allow irradiating only the regions to be expectedly reversed magnetically (e.g. a region including point A) with light. Therefore, the use of master information carrier 1 also allows increasing a temperature of the regions to be expectedly reversed magnetically and decreasing the coercive force of the regions. For instance, with the transcribing and recording magnetic field shown in FIG. 4, even if the coercive force of the medium is greater than the transcribing and recording magnetic field applied to point A, transcribing and recording can be carried out. In other words, although the method disclosed in prior art 1 cannot transcribe and record signals on a medium having high coercive force, the use of master information carrier 1 of the present invention and light irradiation allow transcribing and recording signals with ease on such a high-coercive medium.

The expressions of “translucency” and “transmission” do not strictly require “100% transmission”. In a similar manner, the expressions of “light-proof” and “not transmitted” do not strictly require “to block light 100%”. In order to explicitly explain the features of the present invention, this paper sometimes uses such expressions as if they mean “100% light transmission” and “100% light-proof”. The advantage of the present invention can be achieved by transmitting a larger amount of light irradiated through the regions where no ferromagnetic thin-films 3 exists than through the other regions where ferromagnetic thin-films 3 exist. In this case, ferromagnetic thin-film 3 has a lower transmittance of light 4 irradiated than non-magnetic substrate 2.

FIG. 5 shows a schematic view of master information carrier 1 in accordance with this exemplary embodiment. The surface of this master information carrier 1 has a pattern made of ferromagnetic thin-film 3 and corresponding to the pattern of an information signal array to be recorded on a magnetic recording medium. Master information carrier 1 is used for recording preformat information such as a servo-tracking signal on a disc-shaped magnetic recording medium. Patterns 7 of information signal array are thus prepared at given intervals on a disc along its circumference direction.

Various patterns other than foregoing patterns 7, which are used for recording the preformat information, can be prepared in response to applications on master information carrier 1. For instance, master information carrier 1 shown in FIG. 5 has a pattern of alignment marker 8 made of ferromagnetic thin-film 3, and alignment marker 8 is used for the alignment between a disc (magnetic recording medium) and master information carrier 1. In the case of an HDD, use of such alignment marker 8 allows accurately aligning a center position of the disc to that of pattern 7 formed on master information carrier 1 by using the center hole of a disc as an index.

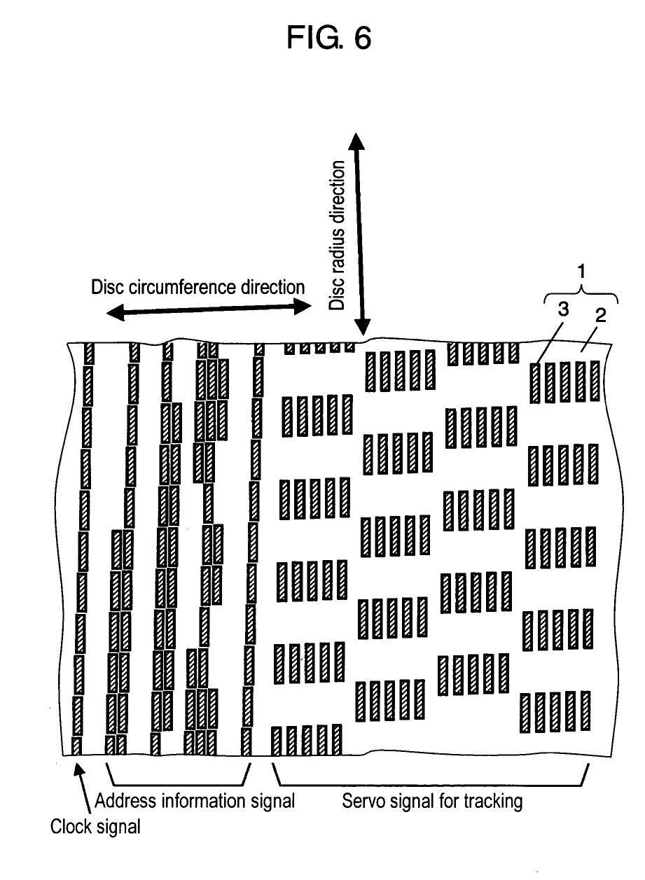

FIG. 6 shows an enlarged plan view illustrating a structure of pattern 7 of the information signal array to be used for recording the preformat information formed on master information carrier 1, and meanwhile, pattern 7 exists at region 200 shown in FIG. 5. Pattern 7 includes a servo-tracking signal, an address information signal, a clock signal that are used to record the preformat information. The lateral direction of FIG. 6 generally agrees with the circumference direction of the disc, i.e. the length direction of a recording track, and the vertical direction of FIG. 6 generally agrees with the radial direction of the disc, i.e. across the width direction of the recording track.

In FIG. 6, the hatched sections are the patterns made of ferromagnetic thin-film 3. Light 4 irradiated to master information carrier 1 does not transmit through those patterns, so that light 4 does not reach the recording medium. On the other hand, white sections without hatching do not have ferromagnetic thin-film formed thereon. Light 4 irradiated to master information carrier 1 thus transmits through these white sections and reaches the disc surface.

The pattern of the information signal array shown in FIG. 6 is formed by all the rectangular patterns generally in parallel with the radial direction of the disc. The length of each rectangular pattern along the radial direction of the disc generally corresponds to a track width of a disc-driving device to which the magnetic recording medium recorded the preformat is mounted.

The disc-driving device, to which the disc including the preformat recorded by master information carrier 1 having the information signal array pattern shown in FIG. 6 is mounted, detects a change in an amplitude of a reproduction signal, where the change is produced by a micro displacement in radial direction of the disc, when a magnetic head reproduces a servo-tracking signal, thereby carrying out the servo-tracking operation.

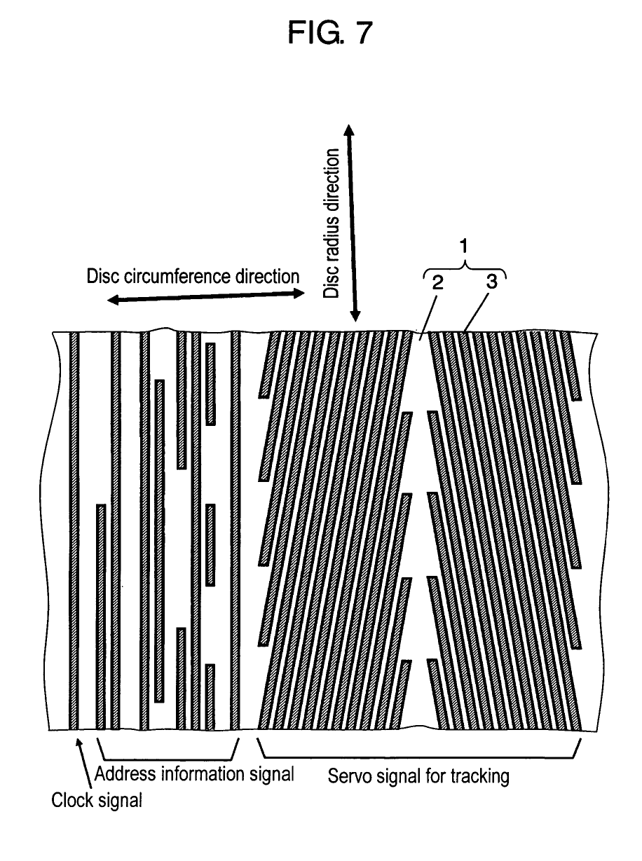

FIG. 7 shows an enlarged plan view illustrating another structure of pattern 7 of the information signal array formed on master information carrier 1, and meanwhile, pattern 7 exists at region 200 shown in FIG. 5. Similar to FIG. 6, FIG. 7 shows a pattern of the information signal array formed on master information carrier 1, namely, the pattern of preformat information, which is to be recorded on a magnetic recording medium, including a servo-tracking signal, an address information signal, and a clock signal. The lateral direction of the drawing generally agrees with the circumference direction of the disc, i.e. the length direction of a recording track, and the vertical direction of the drawing generally agrees with the radial direction of the disc, i.e. across the width direction of the recording track.

In FIG. 7, the hatched sections are the patterns made of ferromagnetic thin-film 3. Light 4 irradiated to master information carrier 1 does not transmit through those patterns, so that light 4 does not reach the recording medium. On the other hand, white sections without hatching do not have ferromagnetic thin-film formed thereon. Light 4 irradiated to master information carrier 1 thus transmits through these white sections and reaches the disc surface.

The pattern of information signal array shown in FIG. 6 is formed by all the rectangular patterns generally in parallel with the radial direction of the disc. On the other hand, the pattern shown in FIG. 7 is formed by all the linear patterns crossing over plural recording tracks consecutively along the radial direction. However, some patterns run not in parallel with the radial direction of the disc.

The disc-driving device, to which the disc including the preformat recorded by master information carrier 1 having the information signal array pattern shown in FIG. 7 is mounted, detects a change in an amplitude of a reproduction signal, where the change is produced by a micro displacement in radial direction of the disc, when a magnetic head reproduces a servo-tracking signal, thereby carrying out the servo-tracking operation.

The pattern shown in FIG. 7, i.e. the pattern used in a method of detecting a phase of a reproduction signal, is subjected to a fewer external disturbance noises than the pattern shown in FIG. 6, i.e. the pattern used in a method of detecting an amplitude of a reproduction signal. The pattern shown in FIG. 7 thus has an advantage of allowing more accurate servo-tracking.

The pattern shown in FIG. 7 cannot be transcribed or recorded by a conventional preformat recording method using a servo-tracking signal with a magnetic head because of the following reasons: a recording gap of the magnetic head has a finite-width of a recording track, and the gap cannot have an arbitrary angle with respect to the radial direction of the disc.

The preformat information shown in FIG. 6 and FIG. 7 maintains, in general, its recording frequency although the radius changes, so that a recording wavelength (a length of one cycle in the circumference direction of a disc) changes proportionately to a change in the radius. The recording wavelength can be found from: (relative speed of disc vs. magnetic head)/(recording frequency), where the relative speed can be calculated by: 2×λ×(radius)×(rpm of the disc).

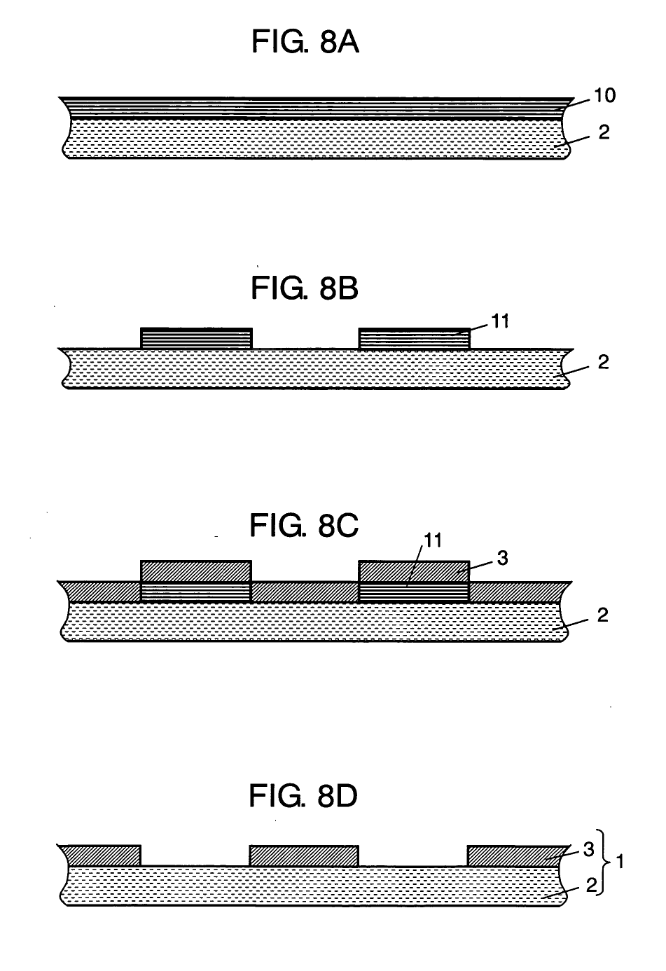

FIG. 8A-FIG. 8D show a method of manufacturing master information carrier 1 in accordance with the exemplary embodiment. First, as shown in FIG. 8A, apply photo-resist 10 onto translucent non-magnetic substrate 2. Then as shown in FIG. 8B, expose substrate 2 with photo-resist 10 to light using a photo mask having a pattern corresponding to an information signal array, thereby developing and forming resist pattern 11 corresponding to the information signal array. Then as shown in FIG. 8C, form light-proof ferromagnetic thin-film 3 on resist pattern 11 and non-magnetic substrate 2 exposed. After this step, remove resist pattern 11 and ferromagnetic thin-film 3 formed on resist pattern 11. In other words, unnecessary ferromagnetic thin-film 3 is removed by a lift-off process. As shown in FIG. 8D, those preparations result in obtaining master information master information carrier 1 having a given pattern made of ferromagnetic thin-film 3 formed on non-magnetic substrate 2.

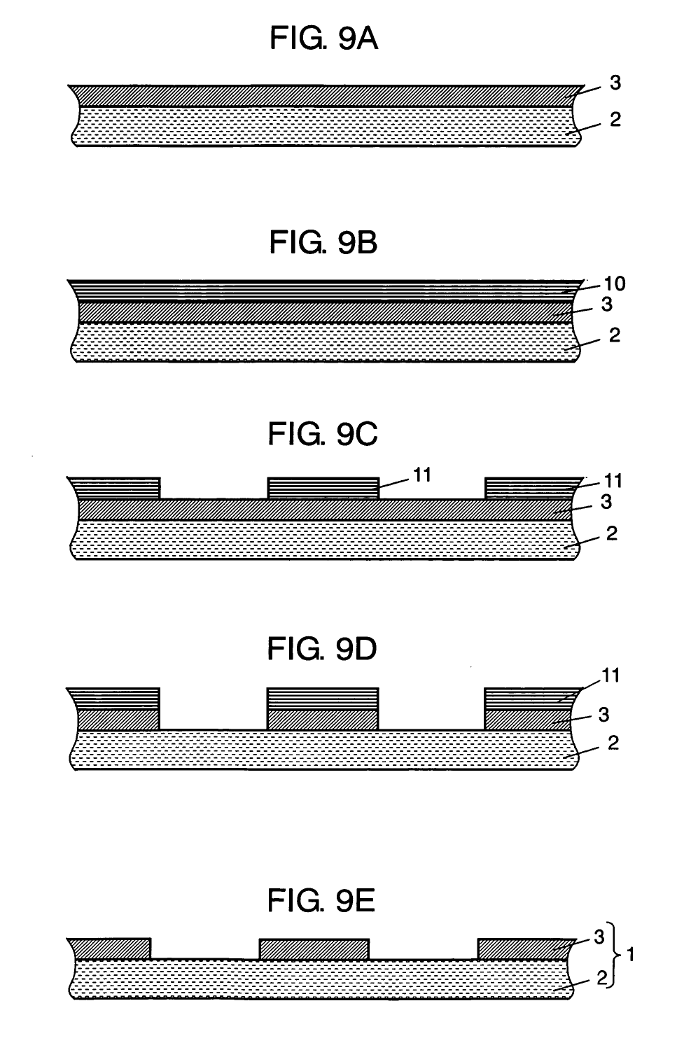

FIG. 9A-FIG. 9E show another method of manufacturing master information carrier 1 in accordance with this exemplary embodiment. First, as shown in FIG. 9A, form light-proof ferromagnetic thin-film 3 on the entire surface of translucent non-magnetic substrate 2. Then as shown in FIG. 9B, apply photo-resist 10 on top of that. Next, as shown in FIG. 9C, expose substrate 2 with photo-resist 10 to light using a photo mask having a pattern corresponding to an information signal array, thereby developing and forming resist pattern 11 corresponding to the information signal array. Next, as shown in FIG. 9D, provide ferromagnetic thin-film with etching by a reactive etching method or an ion-milling method using resist pattern 11 as a mask. This etching makes ferromagnetic thin-film 3 correspond to the pattern of information signal array. Then remove resist pattern 11, thereby obtaining master information carrier 1, as shown in FIG. 9E, having a given pattern made of ferromagnetic thin-film 3 formed on non-magnetic substrate 2.

Both of the foregoing two methods can manufacture with ease master information carrier 1 of the present invention.

As translucent non-magnetic substrate 2, a substrate to be used for a photo mask and material of a lense can be employed, for instance, glass material such as synthetic quartz, or materials of single crystal such as CaF₂, BaF₂, LiCaAlF₆.

As a material of ferromagnetic thin-film 3, one of the following materials can be used: crystal material generally used for a magnetic head core such as Ni—Fe, or Fe—Al—Si, or amorphous material of Co-group such as Co—Zr—Nb, or Fe-based crystal material such as Fe-Ta-N. Material such as Fe, Co, Fe—Co, which are not used, in general, for the magnetic head core because of their rather higher coercive force, can be used for ferromagnetic thin-film 3 as long as their magnetization is oriented along uni-direction when the DC bias magnetic field is applied thereto. Those ferromagnetic materials are light-proof and have a high reflectance.

In this embodiment, the description goes that each element is made of one uniform material; however they can be formed of plural layers. For instance, the light-proof ferromagnetic thin-film can be formed of plural layers in order to obtain excellent magnetic properties, and the thin-film can include a diffusion preventing layer for suppressing diffusion between the thin-film and the non-magnetic substrate. Further, the thin-film can include a protective layer for increasing chemical stability as well as mechanical strength, or a light blocking layer for increasing the light-proof properties. The translucent non-magnetic substrate can include a reflection preventing layer for increasing the light transmission properties.

Light-proof ferromagnetic thin-film 3 can be formed by a regular method of forming thin-film, such as a spattering method, evaporation method, ion-plating method, or CVD method.

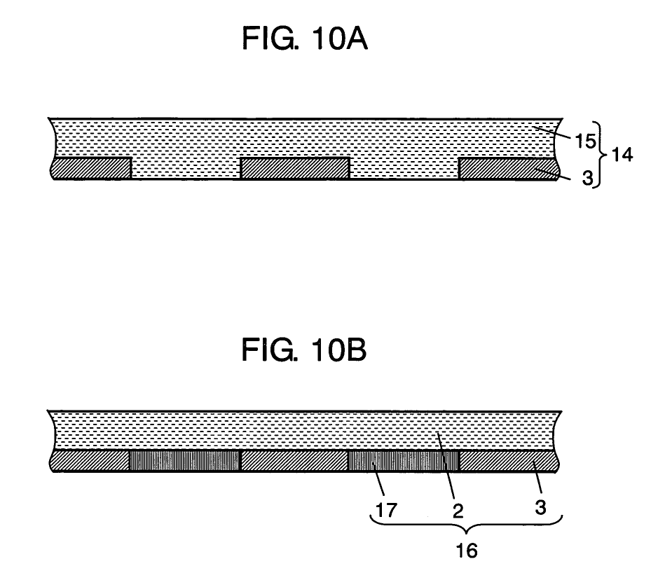

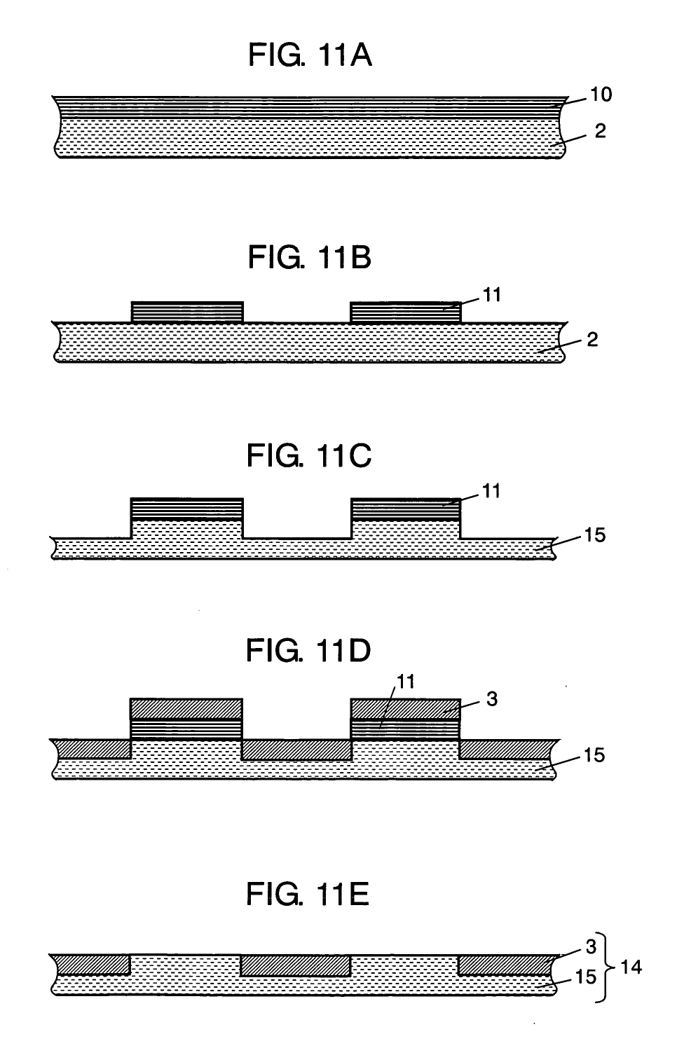

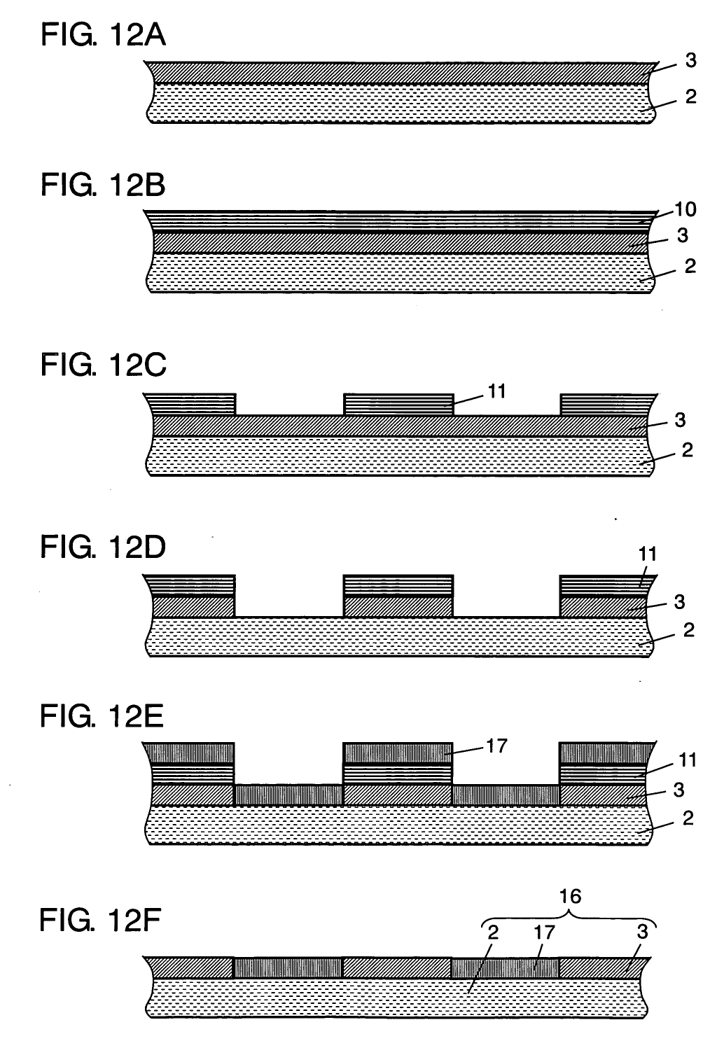

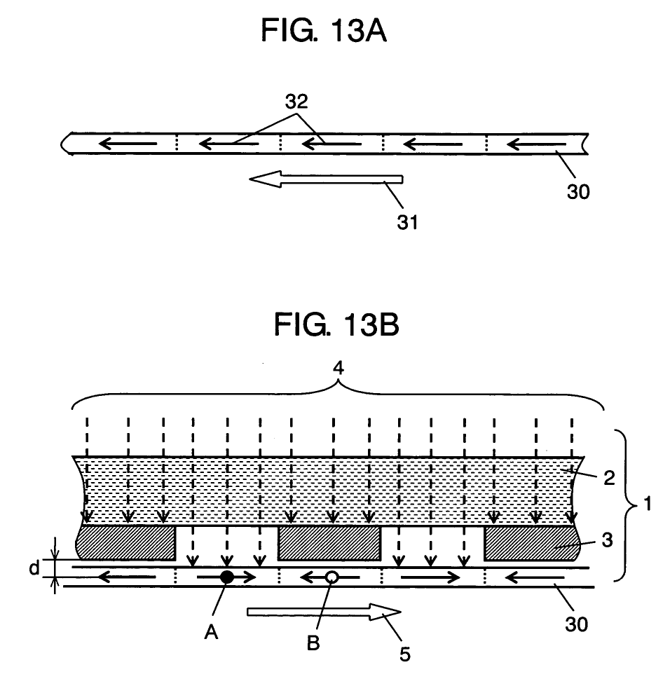

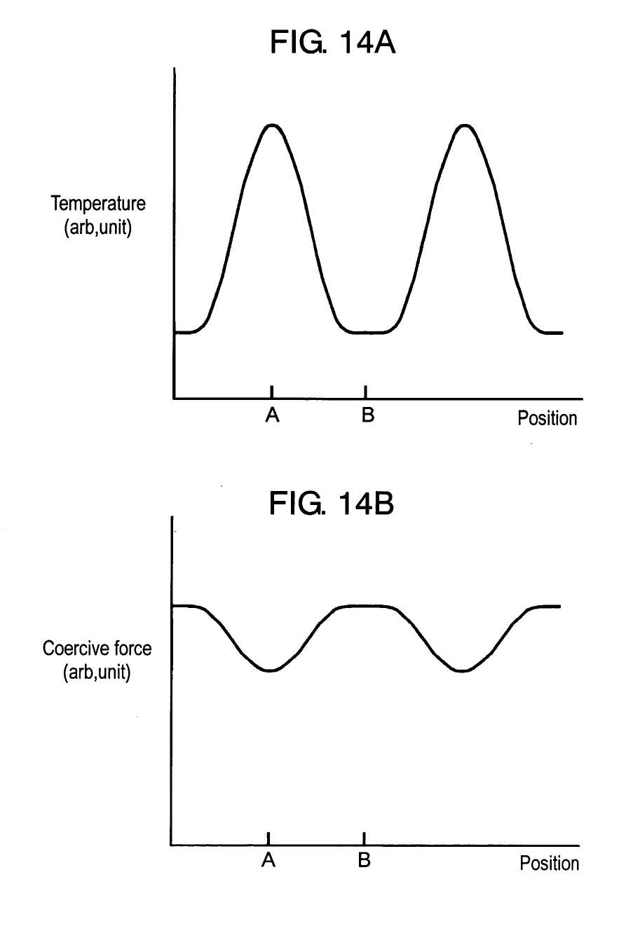

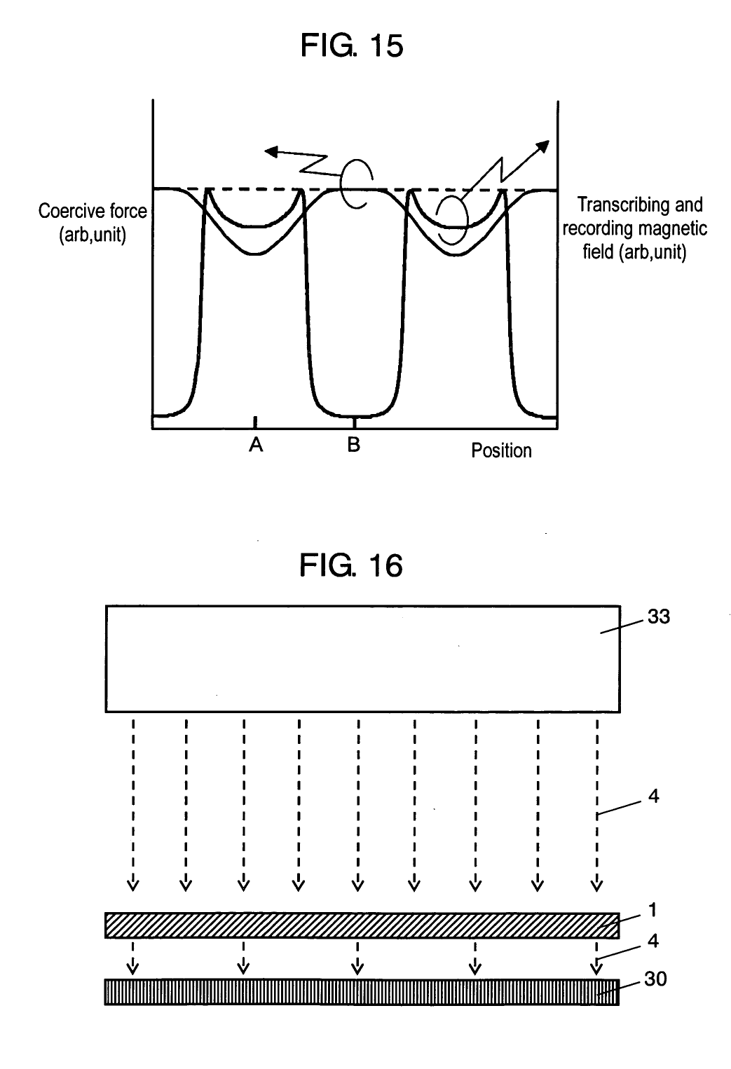

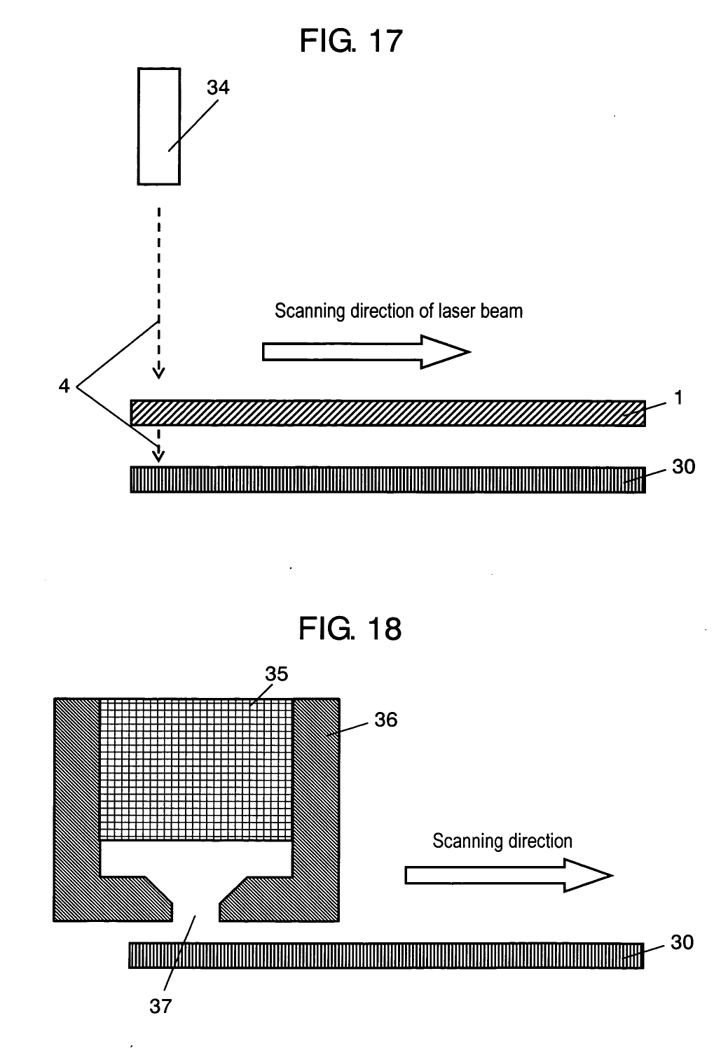

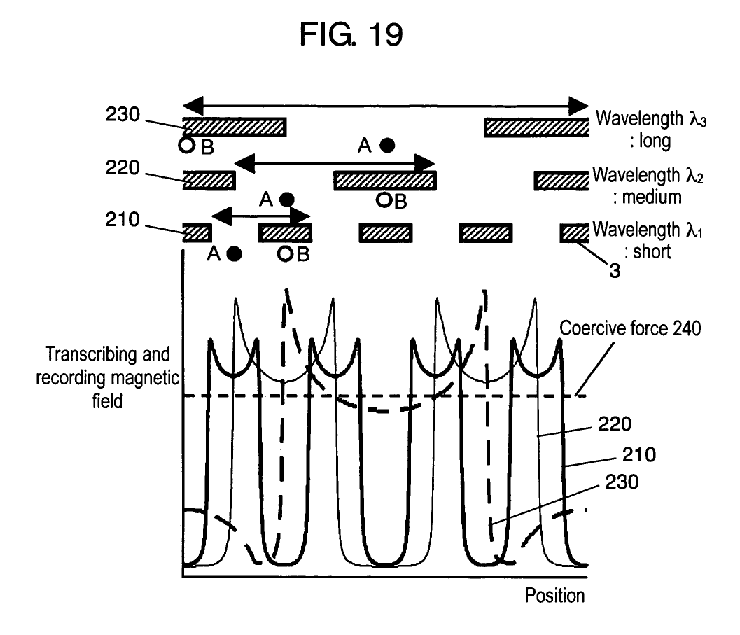

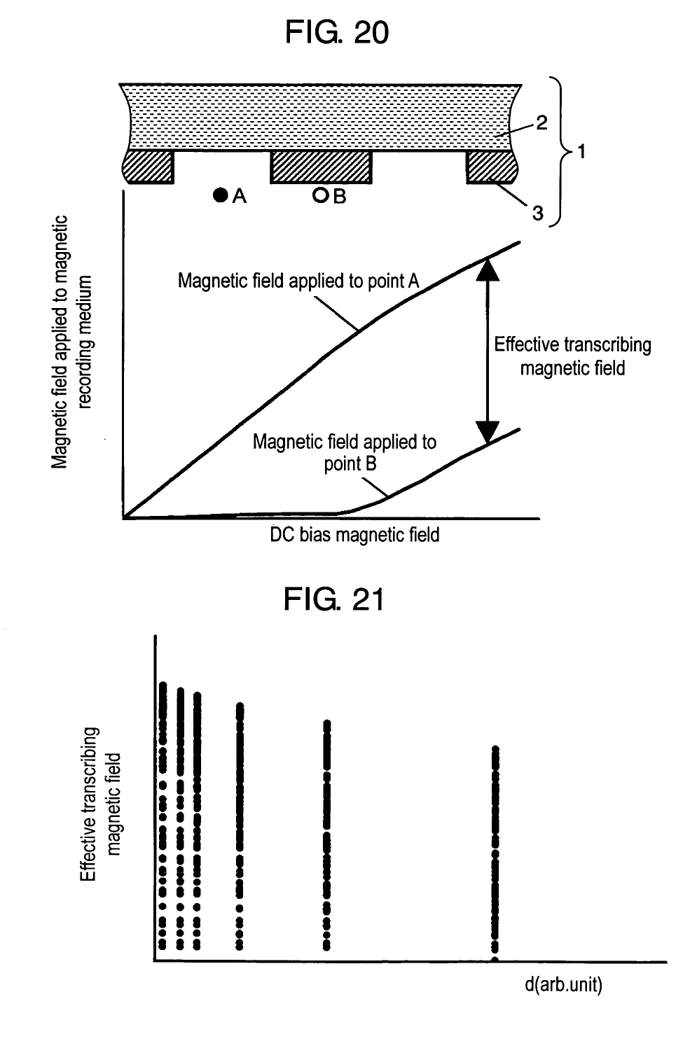

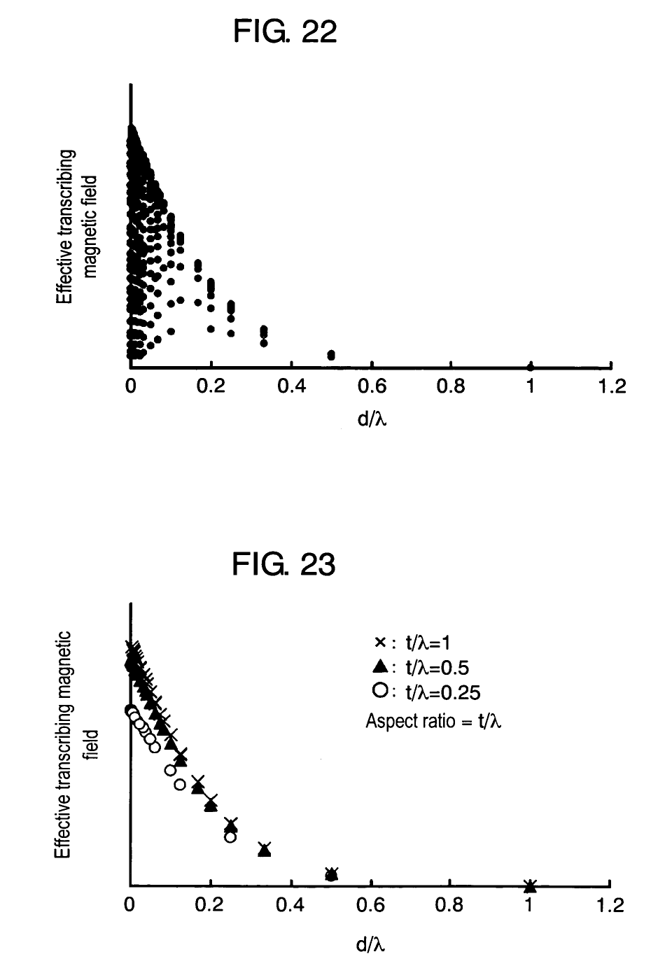

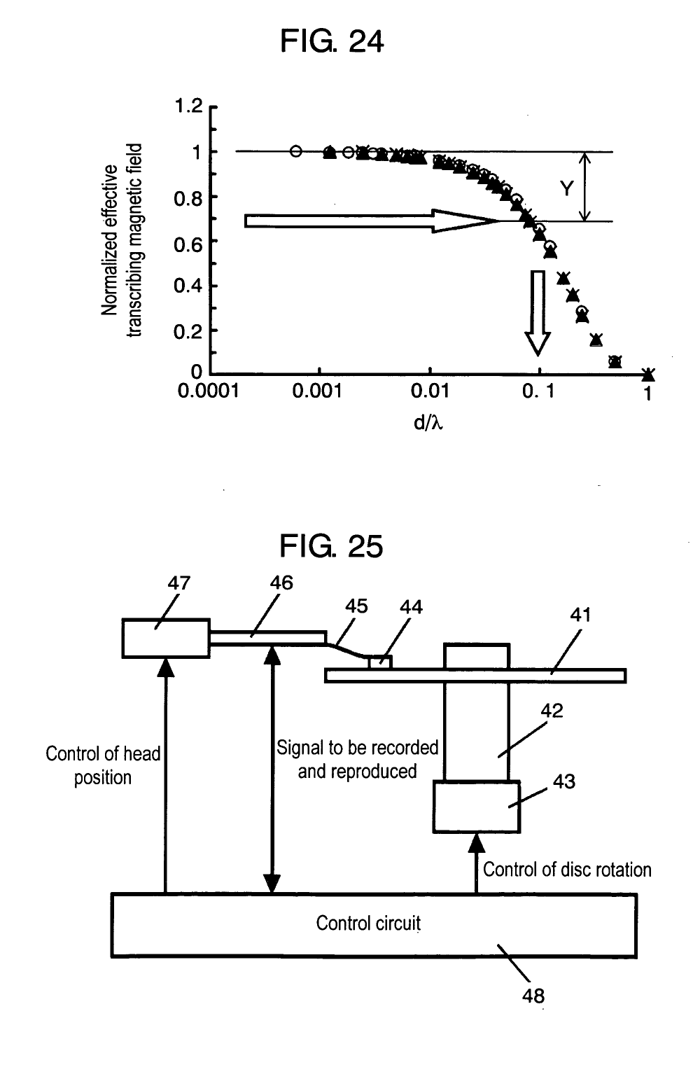

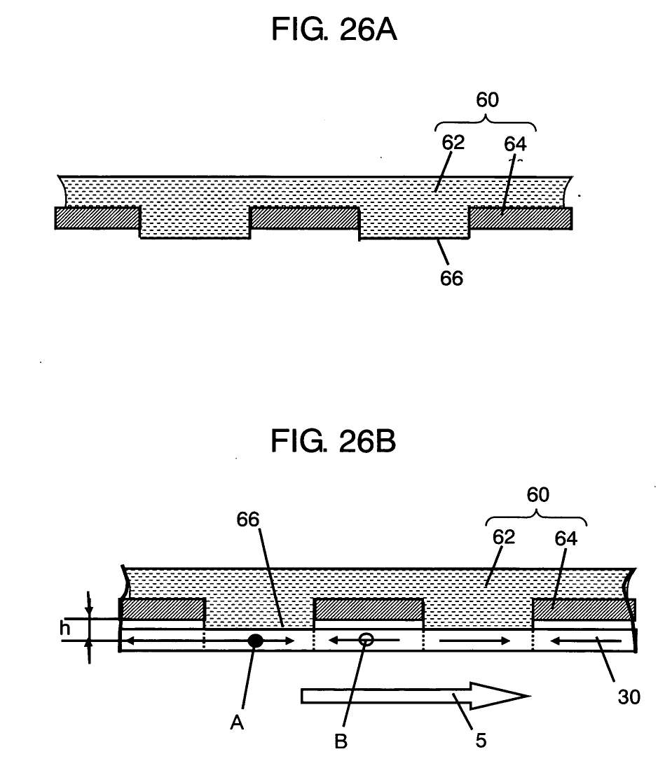

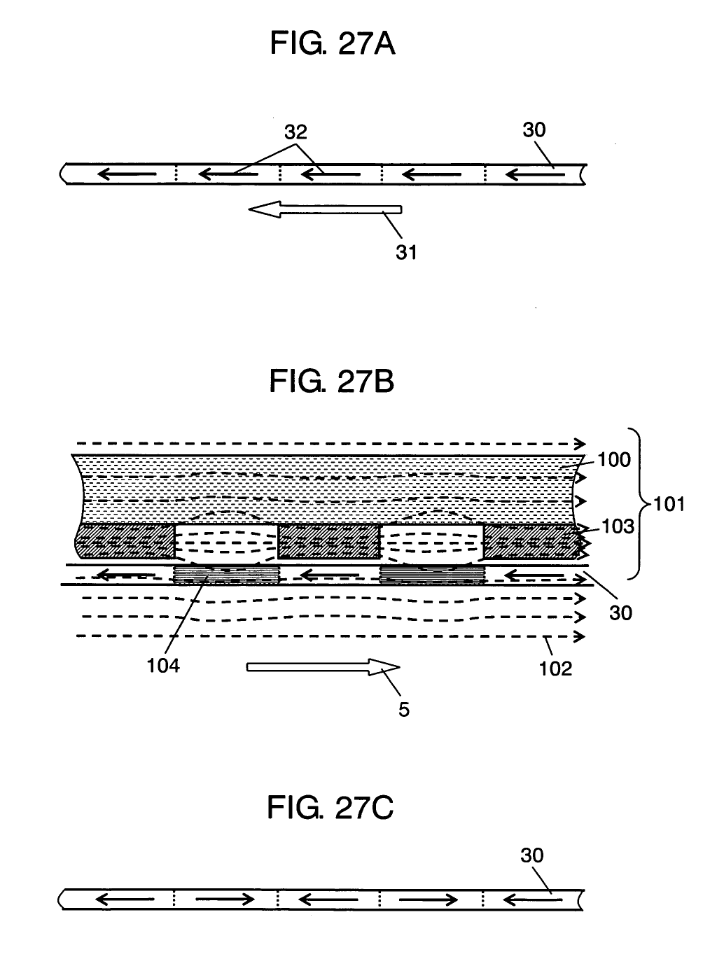

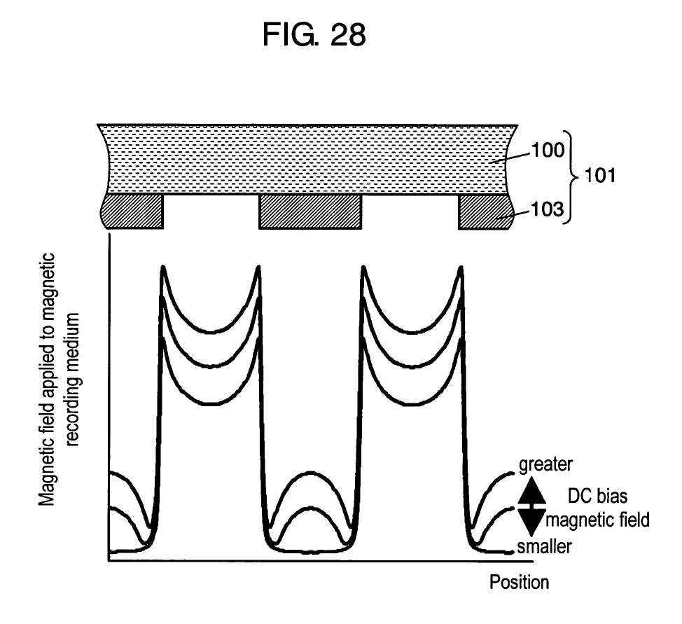

Master information carrier 1 in accordance with this first embodiment has a protruding surface, on which patterned ferromagnetic thin-films are formed, due to the presence of ferromagnetic thin-film 3. However, it can be master information carrier 14 or 16 as FIG. 10A and FIG. 10B show, they include non-magnetic solid body between patterns of ferromagnetic thin-films adjacent to each other, and the light transmits through master information carrier 14 or 16. This structure also obtains a similar advantage to what is discussed above. This structure allows the surface having ferromagnetic thin-film 3 thereon to become generally flat. A flat surface can suppress defectives such as peeling off of ferromagnetic thin-film 3 during use of master information carrier 14 or 16, or during cleaning, so that highly reliable master information carriers 14 and 16 are obtainable.

FIG. 10A shows master information carrier 14 in which non-magnetic substrate 15 exists between ferromagnetic thin-films 3 adjacent to each other. FIG. 10B shows master information carrier 16 in which translucent solid non-magnetic thin-film 17 is buried between ferromagnetic thin-films 3. Translucent non-magnetic thin-film 17 is made of the material of high transmittance and mechanical strength. Thin-film 17 can be formed by a regular method of forming a thin-film, i.e. a similar method to that of ferromagnetic thin-film 3.

FIG. 11A-FIG. 11E show a method of manufacturing master information carrier 14 shown in FIG. 10A. FIG. 12A-FIG. 12F show a method of manufacturing master information carrier 16 shown in FIG. 10B.

The method shown in FIG. 11A-FIG. 11E is similar to the method shown in FIG. 8A-FIG. 8D, so that the following description refers to mainly the steps different from those shown in FIG. 8A-FIG. 8D. As shown in FIG. 11B, the steps up until forming resist pattern 11 corresponding to the information signal array remain unchanged. Then translucent non-magnetic substrate 2 undergoes an etching step by the reactive ion etching method or the ion-milling method using resist pattern 11 as a mask. This etching forms grooves on non-magnetic substrate 15 as shown in FIG. 11C, in which grooves translucent ferromagnetic thin-film 3 is to be buried. Then ferromagnetic thin-film 3 is formed on the entire surface as shown in FIG. 11D. This step is similar to that shown in FIG. 8C. Then the lift-off process is carried out for removing ferromagnetic thin-film 3 together with resist pattern 11, this is similar to the step shown in FIG. 8D. As a result, master information carrier 14, in which ferromagnetic thin-film 3 is buried in the grooves of non-magnetic substrate 15, is obtainable as shown in FIG. 1E.

Manufacturing method shown in FIG. 12A-FIG. 12F is similar to that shown in FIG. 9A-FIG. 9D up to the steps shown in FIG. 12A-FIG. 12D. After the step shown in FIG. 12D, translucent solid non-magnetic thin-film 17 is formed on resist pattern 11 remained on light-proof ferromagnetic thin-film 3 and translucent non-magnetic substrate 2 exposed by etching ferromagnetic thin-film 3, as shown in FIG. 12E. Then as shown in FIG. 12F, non-magnetic thin-film 17 formed on resist pattern 11 and resist pattern 11 per se are removed by the lift-off process. As a result, master information carrier 16, in which solid non-magnetic thin-film is buried between ferromagnetic thin-films 3 adjacent to each other, is obtainable.

Meanwhile, the order of forming light-proof ferromagnetic thin-film 3 and translucent non-magnetic thin-film 17 shown in FIG. 12A-FIG. 12F can be reversed with the same result. Use of the manufacturing methods shown in FIG. 11A-FIG. 11E or FIG. 12A-FIG. 12F allows manufacturing master information carrier 14 or master information carrier 16 shown in FIG. 10A or FIG. 10B with ease.

### Exemplary Embodiment 2

FIG. 13A and FIG. 13B show sectional views illustrating a recording method, in accordance with the second exemplary embodiment, of recording a master information signal on a magnetic recording medium by using master information carrier 1 demonstrated in the first embodiment.

First, as shown in FIG. 13A, apply DC erasing magnetic field 31 to the magnetic recording medium (only magnetic recording layer 30 is shown), thereby erasing layer uniformly with DC along the surface direction of magnetic recording layer 30. As a result, DC erased magnetization 32 is formed along the surface direction.

Then as shown in FIG. 13B, place master information carrier 1 opposite to the magnetic recording medium (only magnetic recording layer 30 is shown), then irradiate carrier 1 with light 4, and apply DC bias magnetic field 5 having a polarity reverse to the DC erasing magnetic field to magnetic recording layer 30. As a result, the master information signal can be transcribed and recorded on the magnetic recording medium.

Master information carrier 1 includes translucent non-magnetic substrate 2, on which a pattern corresponding to the information signal array and made of ferromagnetic thin-film 3, is formed. Light 4 is thus irradiated to the surface of the medium only locally at regions between ferromagnetic thin-films adjacent to each other, so that the surface of the medium can be heated at those regions.

The coercive force of a magnetic recording medium, in general, lowers as the temperature rises, and the apparent coercive force becomes almost zero (0) around the Curie temperature where magnetization disappears. In other words, the coercive force of only the regions, which is irradiated with light, can be lowered.

Similar to what is shown in FIG. 3B, in this second embodiment, application of the DC bias magnetic field 5 generates the magnetic field, which concentrates on ferromagnetic thin-film 3 and diverges in other sections. In FIG. 3, the greater magnetic field than DC bias magnetic field 5 is thus applied around point A, and as shown in FIG. 3B, a smaller magnetic field than DC magnetic field 5 is applied around point B. FIG. 4 facilitates understanding this mechanism. This magnetic field is a transcribing and recording magnetic field to transcribe and record a magnetized pattern corresponding to a preformat pattern made of the ferromagnetic thin-film 3. The great magnetic field around point A can magnetically reverse the magnetization along the DC bias magnetic field.

The region around point A, where the magnetization is reversed, is irradiated with light 4. In other words, use of the recording method allows applying a considerably great transcribing and recording magnetic field only to the region of which magnetization is expectedly to be reversed, and lowering the coercive force of the region. As a result, this recording method can transcribe and record information on the magnetic recording medium on which the recording method disclosed in prior art 1 cannot transcribe and record the information because of the greater coercive force.

FIG. 14A shows a temperature distribution of the magnetic recording medium when the medium is irradiated with light 4. This distribution refers not to the entire medium but to magnetic recording layer 30. FIG. 14A tells that the temperature distribution is broader than the distribution of transcribing and recording magnetic field shown in FIG. 4 because the heat energy produced by light 4 diffuses due to heat conduction in the medium. The coercive force changing in response to the temperature of magnetic recording layer 30 thus becomes broader than the transcribing and recording magnetic field. FIG. 14B shows a coercive force distribution in the magnetic recording medium when the medium is irradiated with light 4.

FIG. 15 shows a distribution of coercive force in a magnetic recording medium and a distribution of transcribing and recording magnetic field when master information carrier 1 is irradiated with light 4. A broken line in FIG. 15 shows a distribution of the coercive force in the medium without light irradiation, and this force stays at the same level. The coercive force at non-irradiation is greater than the transcribing and recording magnetic field applied to point A, so that transcribing and recording cannot be carried out. However, the light irradiation reduces the coercive force of the medium around point A to a lower level than the transcribing and recording magnetic field applied to point A, so that transcribing and recording can be carried out.

In the case of using the recording method in accordance with this second embodiment, the boundary between a region magnetically reversed (around point A) and a region magnetically not-reversed (around point B) is determined by a distribution pattern of the transcribing and recording magnetic field. In this second embodiment, the distribution of the transcribing and recording magnetic field changes so steeply that a width of the magnetic transition at the boundary becomes narrow. As a result, a quality reproduced signal can be obtained.

The recording method in accordance with the second embodiment does not require the temperature of the magnetic recording medium to rise around Curie temperature, but the medium can be heated to the utmost so that the coercive force of the medium becomes less than the transcribing and recording magnetic field applied to point A. The amount and the time-span of light irradiation thus can be small. As a result, the use of the recording method in accordance with the second embodiment can achieve a productivity as excellent as that of the transcribing and recording method disclosed in prior art 1.

With respect to the recording method in accordance with the second embodiment, a magnetic recording medium has undergone the DC erasing; however, if this DC erasing is omitted, an advantage similar to what is discussed above can be also achieved. The DC erasing, yet, protects the medium against dispersion of initial magnetization, and increases stability of a reproduced signal, so that it is preferable for the medium to undergo the DC erasing.

The recording method in accordance with the second embodiment works well on the following media:
in-plane magnetic recording media made of alloy thin-film having Co and Cr as the main ingredients, or the alloy thin-film to which chemical elements such as Pt and Ta are added;
in-plane magnetic recording media made of granulite thin-film having Co and SiO₂, or Co, Pt and SiO₂ as the main ingredients;
magnetic recording media made of orthorhombic evaporated film having Co and O, or Co, Ni and O as the main ingredients;
vertical magnetic recording media made of alloy thin-film having Co and Cr, or the alloy thin-film to which chemical elements such as Pt and Ta are added;
vertical magnetic recording media made of multi-layer thin-film having Pt film and Co alternately laminated, or Pd film and Fe alternately laminated; and
vertical magnetic recording media made of iron-oxide based magnetic thin-film such as barium ferrite, or formed of magnetic coating.

Use of the recording method in accordance with the second embodiment on the vertical magnetic recording medium needs the DC bias magnetic field applied in parallel with the film-surface of the medium. At this time, a magnetic field generated near the end of ferromagnetic thin-film and vertical to the film surface becomes the transcribing and recording magnetic field.

FIG. 16 shows a sectional view illustrating a structure of irradiating master information carrier 1 with light 4 in the method of recording a master information signal on a magnetic recording medium. As shown in FIG. 16, the entire surface of master information carrier 1 is irradiated with light 4 supplied from lamp 33. Light 4 transmits through master information carrier 1 correspondingly to ferromagnetic pattern formed on master information carrier 1, then projects the pattern on the surface of the magnetic recording medium (only magnetic recording layer 30 is shown). An accurate projection of the pattern onto the medium surface requires light 4 incident vertically and uniformly to master information carrier 1. If light 4 enters into master information carrier 1 slantingly from random directions, the slanting light produces scattered light which sometimes lowers a recording resolution. In view of this, lamp 33 preferably supplies incident lights in parallel with each other and entering vertically to the entire surface of master information carrier 1.

Whether or not light 4 irradiated to master information carrier 1 can transmit through master information carrier 1 and reach to the surface of the medium depends on the wave length of light 4 besides the presence of the ferromagnetic thin-film which blocks light 4. For instance, use of infrared light having a wavelength of approx. 1.5 μm as light 4 to an information signal array pattern having 1.0 μm line width, little amount of this infrared light transmits through the region between the ferromagnetic thin-films adjacent to each other. The medium thus cannot be heated, so that its coercive force cannot be lowered. Lamp 33 thus preferably supplies light 4 having a shorter wavelength. For instance, an ultraviolet (UV) ray lamp is preferably used as lamp 33 to an information signal array pattern having approx. 0.5 μm line width, so that light 4 can transmit through the region between the ferromagnetic thin-films adjacent to each other. Use of deep UV ray lamp having a wavelength of not longer than 0.25 μm allows light 4 theoretically to transmit through an information signal pattern having approx. 0.25 μm line width. The shorter wavelength of light 4 can work on the narrower pattern of information signal array.

On the other hand, as shown in FIG. 16, in the case of using lamp 33 for irradiating uniformly the entire surface of master information carrier 1, the power of lamp 33 diverges all over the entire face. Therefore, some irradiated regions are possibly heated insufficiently due to less light irradiation depending on a place of master information carrier 1 or the magnetic properties of the medium.

In such a case, as shown in FIG. 17, laser light-source 34 is used for local irradiation while the laser beam scans along the surface of master information carrier 1, so that the entire surface of the medium can be irradiated with light. Instead of moving the laser beam, master information carrier 1 and the medium can be moved. In this case, a lump-sum recording on the entire surface of the medium cannot be done, so that the productivity of the preformat recording becomes somewhat lower than that of the structure shown in FIG. 16.

However, a spot size of the laser beam can be larger at least by 108 times than the minimum recording unit in a line recording with a conventional magnetic head. (cf minimum recording unit=a bit area of a signal recorded on a disc, i.e. a magnetic recording medium) Use of a laser beam of high power can produce a linear light-source, so that this ratio can be greater. As a result, the use of laser beam can achieve substantially greater productivity than the preformat recording method using a conventional magnetic head.

FIG. 18 shows a sectional view illustrating a mechanism of applying a magnetic field to a magnetic recording medium in a method of recording a master information signal on the medium. This magnetic field is used for DC erasing the medium and for applying a DC bias magnetic field. A magnetic flux generated from permanent magnet 35 is focused by yoke 36 made of ferromagnetic material, and the magnetic field is applied around magnetic gap 37 of the magnetic recording medium (only magnetic recording layer 30 is shown). Permanent magnet 35 and yoke 36 move relatively to and along the surface of the magnetic recording medium, e.g. move magnet 35 and yoke 36 along the arrow mark in FIG. 18, thereby applying the magnetic field on the entire surface of the magnetic recording medium.

In FIG. 18, permanent magnet 35 and yoke 36 are placed on the one side of the magnetic recording medium (above the magnetic recording medium in FIG. 18); however, they can be placed on both the sides of the magnetic recording medium (above and under the magnetic recording medium in FIG. 18). Placement of magnets 35 and yokes 36 on both the sides allows canceling unnecessary vertical magnetic field (vertical direction in FIG. 18) and increasing necessary in-plane magnetic field (horizontal direction in FIG. 18). In stead of permanent magnet 35, an electromagnet that produces a magnetic flux by supplying a current through the coil can be used. In the case of using the electromagnet, adjustment of the current applied allows, with ease, strengthening the bias magnetic field, or changing the bias magnetic field synchronizing with the relative movement to the magnetic recording medium or with the light irradiation.

The magnetic field can be applied without using the yoke; however, in this case a magnetic efficiency lowers, so that it is rather difficult to increase the magnetic field applied. The current thus must be increased, or another measure should be taken.

Light irradiation at the same time with an application of the bias magnetic field is necessary, which limits a structure of a transcribing device. To be more specific, a structure, in which the permanent magnet and the yoke do not block the light irradiation, is required. For instance, in the case of using the method of light irradiation shown in FIG. 16 and FIG. 17, the permanent magnet and the yoke can be placed on the opposite side of the magnetic recording medium (only magnetic recording layer 30 is shown) with respect to master information carrier 1 (under the magnetic recording medium in FIG. 16 and FIG. 17). Placement of magnet 35 and yoke 36 under the magnetic recording medium in FIG. 16 and FIG. 17 prevents light 4 from being blocked.

In the case of using laser light-source 34 shown in FIG. 17, the yoke shape can be changed so that the laser beam can transmit through and vertically irradiate the surface of master information carrier 1. This structure prevents the permanent magnet and the yoke form blocking light 4 even if laser light-source 34, permanent magnet 35 and yoke 36 are placed along the same direction. This unidirectional placement allows double-side transcribing and recording at the same time on a double-sided magnetic recording medium.

FIG. 19 shows a distribution of the transcribing and recording magnetic field applied to a magnetic recording medium when recording wavelength “λ” of an information signal of a master information carrier is changed. In a pattern corresponding to an information signal array formed of a ferromagnetic 15 thin-film, the information signal have recording wavelength “λ”, which takes a different value depending on a place of the carrier. In other words, the master information of the carrier has a shorter information signal array formed of ferromagnetic thin-film 3, e.g. inside the carrier along the radial direction, and has a longer array outside the carrier along the radial direction.

As shown in FIG. 19, the magnetic field applied to point A decreases as recording wavelength “λ” becomes longer. In the case of the shortest recording wavelength “λ₁”, the transcribing and recording magnetic field is distributed as shown with bold-solid line 210. In the case of the recording wavelength takes a medium value “A λ₂”, the magnetic field is distributed as shown with solid line 220. In the case of the longest wavelength “λ₃”, the magnetic field is distributed as shown with broken line 230. Those lines tell that the magnetic field applied to point A decreases as recording wavelength “λ” becomes longer.

This phenomenon is caused by the fact that a longer recording wavelength “λ” needs a longer distance between ferromagnetic thin-films 3 adjacent to each other, so that the magnetic flux around point A substantially diverges. To be more specific, a longer recording wavelength “λ” requires a longer length of ferromagnetic thin-film 3. As a result, demagnetizing field of ferromagnetic thin-film 3 decreases, and an mount of the magnetic flux flowing through ferromagnetic thin-film 3 increases. However, the distance between ferromagnetic thin-films 3 adjacent to each other increases more than the increased amount of the magnetic flux, so that the transcribing and recording magnetic flux applied around point A resultantly decreases.

On the other hand, the magnetic field is applied around point B only when recording wavelength “λ” takes the longest value “λ₃”. Almost no magnetic field is applied around point B in other cases, namely in the case of wavelength “λ₁” or “λ₂”. A longer ferromagnetic thin-film 3 entails a greater amount of magnetic flux to flow through ferromagnetic thin-film 3. As a result, magnetization becomes saturated with ease at a longer ferromagnetic thin-film 3 even the same amount of DC bias magnetic field is applied. To be more specific, in FIG. 19, the magnetization of ferromagnetic thin-film 3 is saturated when recording wavelength “λ” takes the longest value “λ₃”, so that unnecessary magnetic field is applied around point B. Meanwhile, the transcribing and recording magnetic field shown in FIG. 19 indicates the case where the DC bias magnetic field is kept at a given level and only recording wavelength “λ” changes.

Under the conditions shown in FIG. 19, i.e. recording wavelength “λ” and the transcribing and recording magnetic field applied to the magnetic recording medium, when information is transcribed and recorded on the magentic recording medium having the coercive force shown with dotted line 240, the magnetic field becomes lower than the coercive force only around point A where the recording wavelength takes the longest value “λ₃”. Thus irradiate the vicinity of point A, where the longest recording wavelength “λ₃” is available, with light 4 for lowering the coercive force, so that the transcribing and recording performance can be considerably improved. In other words, in the case of transcribing and recording an information signal having various recording wavelengths “λ” as discussed above, the recording method of the present invention can achieve with ease an excellent transcribing and recording.

In general, a preformat information signal has various recording wavelengths, e.g. the information signal pattern shown in FIG. 5-FIG. 7 has recording wavelength “λ” that greatly changes in proportion to a radius of the master information carrier. Therefore, quality transcribing and recording is requested at the respective recording wavelengths. Use of the recording method of the present invention can record a master information signal on a magnetic recording medium by controlling an amount of light irradiation applied to the medium in response to recording wavelength “λ” of the information signal. As a result, a temperature of the magnetic recording medium can be controlled, and the coercive force of the magnetic recording medium can be controlled with ease.

In the case of using the light irradiation by scanning a laser beam, an amount of laser irradiation (e.g. irradiation time or irradiation power) to master information carrier 1 can be controlled in response to recording wavelength “λ” at an irradiation region. In this case, irradiation only to the regions having a longer recording wavelength “λ” with the laser beam can shorten the scanning time of the laser beam, thereby increasing the productivity.

On the other hand, in the case of using the lamp shown in FIG. 16 for irradiating uniformly the entire master information carrier with light, it is not so easy to change locally an amount of light irradiation in response to recording wavelength “λ”. However, as already discussed, whether or not light 4 irradiated transmits through master information carrier 1 and reaches to the surface of a magnetic recording medium depends on the wavelength of light 4 and a width of transmitted regions. This relation indicates that light 4 transmits through master information carrier 1 and reaches to the surface of the magnetic recording medium in the region where the information signal takes a longer recording wavelength “λ”. On the contrary, light 4 encounters difficulty to reaches the magnetic recording medium surface in the region where the information signal takes a shorter recording wavelength “λ”. In other words, positive use of this relation allows changing an amount of the light irradiation to a magnetic recording medium in response to recording wavelength “λ” of an information signal. As a result, a quality transcribing and recording can be expected from a master information carrier having different recording wavelengths to a medium.

Light irradiation only to the region having a longer recording wavelength of the information signal can produce the advantage of the present invention, so that it is possible to delay light 4 to have a shorter wavelength. This is a substantially a big advantage.

FIG. 20 shows a relation between the DC bias magnetic field and the magnetic field applied to point A and point B. The magnetic field applied at point A simply increases as the DC bias magnetic field increases. On the other hand, the magnetic field applied to point B stays almost at zero while the DC bias magnetic field remains at a small value, but it simply increases when the DC magnetic field exceeds some value. The change of the magnetic filed applied to point B is caused by a change in magnetization of ferromagnetic thin-film 3. To be more specific, when the magnetization of ferromagnetic thin-film 3 is not saturated yet, almost all the magnetic flux flow through ferromagnetic thin-film 3, so that the magnetic field applied around point B close to the ferromagnetic thin-film 3 becomes almost zero (0). However, when the magnetization of ferromagnetic thin-film 3 is saturated, ferromagnetic thin-film 3 cannot collect the magnetic flux any more, so that the magnetic field applied around point B increases.

When the magnetization of ferromagnetic thin-film 3 is saturated, slopes of the magnetic field applied to points A and B are similar to each other, and both of the slopes have 45 degrees, i.e. one increment of the DC bias magnetic field increases the magnetic fields applied to points A and B by one. A greater difference between the magnetic fields applied to point A and point B indicates a higher transcription performance. Hereinafter this difference between the two magnetic fields is referred to as an effective transcribing magnetic field. The effective transcribing magnetic field is found in an average magnetic field applied to a magnetic recording layer, so that points A and B are assumed to exist at the center section of the film thickness of the recording layer.

FIG. 21 shows calculation results of the effective transcribing magnetic field by varying the following parameters: i.e. “d” representing a distance between ferromagnetic thin-film 3 and the magnetic recording medium; recording wavelength “λ”; and film thickness “t” of ferromagnetic thin-film 3. A correct expression about the distance “d” goes this: as FIG. 13B shows, this distance is measured from ferromagnetic thin-film 3 to point A (B). To be more specific, the foregoing parameters are changed in the following ranges: 0.2 μm ≦λ≦8 μm, 0.1 μm≦t≦2 μm, 5 nm≦d≦200 nm. As FIG. 21 tells the effective transcribing magnetic field decreases at greater distance “d”. No other explicit relations can be found in FIG. 21.

FIG. 22 shows a relation between “d/λ” on the lateral axis and the effective transcribing magnetic field on the vertical axis. The effective transcribing magnetic field decreases at a greater “d/λ”. Similar to FIG. 21, no other explicit relations can be found in FIG. 22.

Next, an aspect ratio is defined as “t/λ”, and three data of the aspect ratio are listed in FIG. 23. Actually “t/λ”=1.0, 0.5, and 0.25 are used as parameters, and a relation between “d/λ” and the effective transcribing magnetic field is found. FIG. 23 tells that the relation between “d/λ” and the effective transcribing magnetic field changes at respective aspect ratios “t/λ”. In other words, it is found that the determination of “t/λ” and “d/λ” determines uniquely the effective transcribing magnetic field. When aspect ratio “t/λ” and “d/λ” of the samples are same, e.g. λ=1 μm, t=0.5 μm, d=50 nm, and λ=0.8 μm, t=0.4 μm, d=40 nm, both of the shapes are similar to each other. Those results tell that application of the same magnetic field to points A and B is as a matter of course. In other words, those results obtained in this embodiment are found not only in the range shown in FIG. 21-FIG. 23 but also found in other wider ranges.

Comparison of the results at the respective aspect ratios “t/λ” tells that the effective transcribing magnetic field increases at greater aspect ratio “t/λ”. The following three reasons constitute grounds for this result: (1) Longer recording wavelength “λ” prolongs a distance between the ferromagnetic thin-films adjacent to each other, so that the magnetic field applied to point A decreases. (2) Longer recording wavelength “λ” prolongs a length of the ferromagnetic thin-film, so that the magnetization tends to be saturated by even a small DC bias magnetic field. Thus unnecessary magnetic field is applied to point B. (3) A thicker ferromagnetic thin-film collects the more magnetic fields thereon.

The effective transcribing magnetic field changes little between aspect ratios “t/λ”=1.0 and “t/λ”=0.5. This result tells that the effective transcribing magnetic field increases little at the aspect ratio of not less than 0.5.

FIG. 24 shows the effective transcribing magnetic field at the respective aspect ratios “t/λ” are normalized by the maximum value of the effective transcribing magnetic field, and this normalization proves that any aspect ratio results in the same. In other words, a relation between the rate of change of the effective transcribing magnetic field and “d/λ” is uniquely determined. FIG. 24 tells that in the range of “d/λ”≧1, the effective transcribing magnetic field becomes almost zero. In this range, the recording method of the present invention, i.e. recording a master information signal on a magnetic recording medium, thus cannot prove its advantage. On the other hand, in the range of “d/λ”<1, the recording method of the present invention can prove its advantage to one degree or another. The distance “d” that establishes “d/λ”=1 corresponds to distance “d₁” between the ferromagnetic thin-film and the magnetic recording medium. To be more specific, when “d₁/λ”<1, and d₁<1 are satisfied, the advantage can be exerted.

In the recording method of the present invention, i.e. the method of recording a master information signal on a magnetic recording medium, a change in the effective transcribing magnetic field, corresponding to a transcribing and recording capability, changes an output of the signal transcribed and recorded. An allowable range of a change in an output is approximately not more than 30%, which requires a change in the effective transcribing magnetic field to be not more than 30%. For instance, in the case of carrying out the transcribing and recording with a ferromagnetic thin-film brought into contact with a magnetic recording medium, if the solid contact between those elements disperses, distance “d” changes, so that the effective transcribing magnetic field also changes. The “d/λ” at the contact section between the thin-film and the medium is so small that the effective transcribing magnetic field applied to the contact section takes almost the maximum value (the normalized effective transcribing magnetic field shown in FIG. 24 is approximately 1). On the other hand, the effective transcribing magnetic field is suppressed to not higher than 30% even at poorly solid contact sections. In other words, the effective transcribing magnetic field should be within the range indicated with Y in FIG. 24, namely, not lower than 0.7. To be more specific, FIG. 24b tells that “d/λ”≦0.1 should be satisfied in order to suppress the change of the effective transcribing magnetic field not higher than 30%. Distance “d” establishing “d/λ”=1 indicates that the ferromagnetic thin-film contacts at least partially of the medium, and corresponds to distance “d₂” between the thin-film and the medium. In other words, when d₂/λ≦0.1, and d₂≦0.1×λ are satisfied, a quality transcribing and recording is achievable.

The satisfaction of d₂≦0.1×λ not only in the case of at least partial contact between the ferromagnetic thin-film and the magnetic recording medium, but also in the case of non-contact between them can suppress the changes of the effective transcribing magnetic field not higher than 30%, so that a super quality transcribing and recording is achievable.

In conclusion, regardless of contact or non-contact between a ferromagnetic thin-film and a magnetic recording medium, the satisfaction of d₂≦0.1×A can achieve a super quality transcribing and recording.

Signal performances are compared between the recording method of the present invention and that disclosed in prior art 1 with respect to various discs having different coercive force from each other. Both the recording methods use a master information carrier with the same structure. To be more specific about master information carrier 1, it is manufactured by the method shown in FIG. 11A-FIG. 11E, and translucent synthetic crystal is used as the non-magnetic substrate, and Co is used as a material of the ferromagnetic thin-film. The thickness of the Co is 0.2 μm, and the recording wavelength of an information signal to be transcribed and recorded changes in proportion to the radius within the range of 1 μm-2.5 μm, and within the range of 0.6 μm-1.5 μm, namely, two types of master information carriers are prepared. Excimer laser having a wavelength of 248 nm is used as the light for irradiation, and its intensity is 60 mJ/cm², beam size is 35 mm×12 mm. Use the magnetic-field application method shown in FIG. 18, and place the carrier on the other side of the laser irradiation. In this examination, the locations of the laser beam source, master information carrier, magnetic disc, permanent magnet, and yoke are not changed but kept at fixed places.

An experiment of varying the recording wavelength within the range of 1 μm-2.5 μm results in obtaining explicitly the advantage of the present invention at the coercive force of the media not less than 4 kOe (320 kA/m). To be more specific, the media having coercive force weaker than 4 kOe show little difference in signal performance by the both recording methods. The signal performance is improved only at the circumference of the disc having around 4 kOe coercive force. The improved area increases at the greater coercive force, and the signal performance improves almost all over the disc when the coercive force exceeds 6 kOe (480kA/m).

Comparison of the improvement degrees within the disc tells that the greater degree of improvement is found closer to the circumference of the disc. The improvement of signal performance indicates an increase in a reproduction output and a decrease in distortion of an output waveform.

Another experiment of varying the recording wavelength within the range of 0.6 μm-1.5 μm results in no achievement of improving the signal performance all over the surface although the coercive force of the medium is increased. To be more specific, in the range of a signal wavelength shorter than 0.8 μm, no improvement in signal performance is found. This result tells that under the laser irradiation condition of this examination, the recording layer region irradiated with the laser beam is not heated enough in the range of the recording wavelength shorter than 0.8 μm. In order to avoid this phenomenon, a laser beam having a shorter wavelength can be used or the intensity of the laser beam can be increased.

A method of manufacturing the magnetic recording medium of the present invention comprises the following steps:
first, forming at least one magnetic recording layer and one protective layer on a plate;
second, forming a lubricating layer on the protective layer;
then placing a pattern corresponding to an information signal array on a nonmagnetic substrate such that a face of the ferromagnetic thin-film of a master information carrier made of ferromagnetic thin-film confronts a magnetic recording layer of the plate;
next, applying a bias magnetic field at least to the magnetic recording layer formed on the plate and the ferromagnetic thin-film of the master information carrier while heating via the carrier locally the medium at the surface confronting a place between the ferromagnetic thin-films adjacent to each other of the carrier, thereby recording a magnetized pattern corresponding to the information signal array onto the magnetic recording layer.

The magnetic recording medium, recorded the magnetized pattern corresponding to the information signal array on the magnetic recording medium, can be manufactured through the foregoing steps.

In the foregoing manufacturing method, use of a translucent nonmagnetic substrate and a light-proof ferromagnetic thin-film together with the local heating at the magnetic recording layer with the irradiation of light-energy transmitted through the region between the ferromagnetic thin-films adjacent to each other allow substantial local heating in a short time. As a result, a fine magnetized pattern can be recorded.

Further in this manufacturing method, the master information carrier can include a projection protruding from the region between the ferromagnetic thin-films adjacent to each other, and the local heating to the magnetic recording layer can be done through this projecion, namely, the heat energy is conveyed through this projection. This heating method allows the local heating with heat conduction through the projection, so that the heating method can be more flexible.

### Exemplary Embodiment 3

FIG. 25 shows a schematic diagram illustrating a magnetic recording and reproducing apparatus in accordance with the third exemplary embodiment of the present invention. As shown in FIG. 25, at least one magnetic disc medium 41 is supported on spindle 42. This magnetic disc medium 41 includes a preformat recorded by the method of recording a master information signal on a magnetic recording medium of the present invention. Magnetic disc medium 41 is rotated by spindle motor 43. Thin-film magnetic head 44 is mounted to actuator arm 46 via suspension 45, and arm 46 is mounted to actuator 47.

This structure allows thin-film magnetic head 44 to move over the surface of magnetic disc medium 41 by the movement of actuator 47. Thin-film magnetic head 44 is placed to confront the surface of magnetic disc medium 41, so that the rotation of magnetic disc medium 41 and the movement of thin-film magnetic head 44 along the radius direction of magnetic disc medium 41 allow thin-film magnetic head 44 to read and write a signal almost all over the disc surface.

Control circuit 48 controls the rotation of magnetic disc medium 41, the position of thin-film magnetic head 44, and a recording and reproducing signal. This structure allows achieving a magnetic recording and reproducing apparatus of high signal quality at an inexpensive cost, and yet, this apparatus includes a preformat recorded and works with high productivity on the magnetic recording media that have greater coercive force due to the higher density recording. In other words, use of the magnetic recording and reproducing apparatus of the present invention can deal with the higher density recording expected in the near future.

The foregoing structure of the present invention is applicable to a variety of embodiments. For instance, this paper refers mainly to a disc used in an HDD; however, the present invention is not limited to this reference. The structure can be applied to magnetic recording media such as FDD, magnetic card, magnetic tape with an advantage similar to what is discussed above.

This paper refers to preformat information signals such as a tracking servo signal, an address information signal, and a clock signal, as an information signal recorded on a magnetic recording medium; however, the information signals applicable to the foregoing structure are not limited to those examples. For instance, a variety of data signals, audio and video signals can be recorded using the foregoing structure. In such a case, a large amount of soft-disc media can be copied at an inexpensive cost.

In the first, second and third embodiments, the transcribing and recording method using the transcribing and recording magnetic field which is generated by applying local heat and a bias magnetic field to a magnetic recording medium. In this case, the magnetic recording medium irradiated with light transmitted through a translucent non-magnetic substrate is used; however, the present invention can be carried out in the following way:

A master information carrier having a projection protruding from a region between the ferromagnetic thin-films adjacent to each other and also having a pattern corresponding to an information signal array on its non-magnetic substrate is used, and the medium is locally heated by conveying heat energy through the projection of the carrier. In this case, the medium can be easily heated by various methods. To be more specific, apply heat to the face of the carrier opposite to the medium with light, laser beam or by a heater, thereby heating the non-magnetic substrate, ferromagnetic thin-film and the projection, so that the medium can be locally heated through the projection. In this case, it is not necessarily to use translucent material or light-proof material for the master information carrier. Thus Si wafer regularly used as substrates of semiconductor devices can be used as the material of the carrier.

FIG. 26 shows a sectional view illustrating the foregoing master information carrier 60 having projections each one of which protrudes from a region between the ferromagnetic thin-films adjacent to each other. Master information carrier 60 comprises non-magnetic substrate 62; and a pattern formed of ferromagnetic thin-film 64 on non-magnetic substrate 62 and corresponding to an information signal array. Master information carrier 60 includes projections 66 protruding by height “h” from the regions between ferromagnetic thin-films adjacent to each other.

Prepare a magnetic recording medium having undergone a DC erasing magnetic field for uniformly erasing a magnetic recording layer along the film face and forming a DC erased magnetic field along the film face. Then place this magnetic recording medium opposing to master information carrier 60 such that projections 66 of non-magnetic substrate 62 solidly contact with the magnetic recording medium. Apply heat to non-magnetic substrate 62 in this status, thereby heating locally the magnetic recording medium. At the same time with the heating, apply a DC bias magnetic field having an opposite polarity to the DC erasing magnetic field to the magnetic recording medium, so that the master information signal is transcribed and recorded on the magnetic recording medium.

When projections 66 are brought into contact solidly with the magnetic recording medium, the following relation is found between projecting amount “h” from ferromagnetic thin-film 64 and distance “d” defined in FIG. 13B:
d=h+(thickness of protective layer)+(thickness of lubricating layer)+(thickness of magnetic recording layer)/2

In order to effect the advantage of the present invention while the relation of d<λ is satisfied, at least the relation of h<λ must be satisfied. In the same manner, in order to effect the better transcribing performance while the relation of d≦0.1×λ is satisfied, at least the relation of h<0.1×λ must be satisfied.

The thickness of the protective layer and that of the lubricating layer refer to the thickness of the protective layer formed on the magnetic recording layer of the medium and that of the lubricating layer formed of the magnetic recording layer.

Each one of the regions between the ferromagnetic thin-films can be a heat generating structure for heating locally the magnetic recording medium instead of using the projections. In this case, the regions are formed of non-magnetic solid body that can generate heat by applying electric power or electromagnetic wave, and the heat energy generated from the regions is conveyed to the magnetic recording medium for heating locally the magnetic recording medium. As a result, the coercive force is reduced, so that quality transcribing and recording can be expected. Use of electric power for heating allows controlling the heat generation by changing an electrical conductivity of the material forming the region between the ferromagnetic thin-films adjacent to each other. Oxide film of iron oxide or ferrite can be used as ferromagnetic material through which electricity hardly runs. In the case of using electromagnetic wave, an appropriate selection of the material also allows controlling the heat generation.

1. A master information carrier comprising:
a non-magnetic substrate having at least translucency; and
a light-proof ferromagnetic thin-film formed on the non-magnetic substrate and patterned corresponding to an information signal array.

2. The master information carrier of claim 1, wherein the carrier includes a translucent non-magnetic solid body at a region between the ferromagnetic thin-films adjacent to each other.

3. The master information carrier of claim 1, wherein the ferromagnetic thin-film is buried in a surface of the non-magnetic substrate.

4. A master information carrier comprising:
a non-magnetic substrate;
a ferromagnetic thin-film formed on the non-magnetic substrate and patterned corresponding to an information signal array; and
a projection protruding from a region between the ferromagnetic thin-films adjacent to each other.

5. The master information carrier of claim 4, wherein the patterned information signal array has a recording wavelength of “λ”, and the projection protrudes by an amount of “h”, wherein protruding amount “h” is set based on the recording wavelength “λ” such that a relation of h<λ is satisfied.

6. The master information carrier of claim 4, wherein the patterned information signal array has a recording wavelength of “λ”, and the projection protrudes by an amount of “h”, wherein protruding amount “h” is set based on the recording wavelength “λ” such that a relation of h<0.1×λ is satisfied.

7. A master information carrier comprising:
a non-magnetic substrate;
a ferromagnetic thin-film formed on the non-magnetic substrate and patterned corresponding to an information signal array; and
a region between the ferromagnetic thin-films adjacent to each other being formed of a non-magnetic solid body to be a heat generating source.

8. The master information carrier of claim 7, wherein the non-magnetic solid body is formed of material having properties of generating heat by one of electric power and electromagnetic wave.

9. A method of manufacturing a master information carrier, the method comprising the steps of:
forming a light-proof ferromagnetic thin-film on a non-magnetic substrate having at least translucency;
forming a resist pattern corresponding to an information signal array on the ferromagnetic thin-film;
etching the ferromagnetic thin-film at a region where the resist pattern does not exist;
forming a translucent non-magnetic thin-film on the resist pattern and a surface of the non-magnetic substrate exposed by the etching; and
removing the non-magnetic thin-film on the resist pattern when the resist pattern is removed.

10. A method of manufacturing a master information carrier, the method comprising the steps of:
forming a resist pattern corresponding to an information signal array on a non-magnetic substrate having at least translucency;
etching the non-magnetic substrate at a region where the resist pattern does not exist for forming a groove;
forming a light-proof ferromagnetic thin-film on the non-magnetic substrate including the resist pattern; and
removing the ferromagnetic thin-film on the resist pattern when the resist pattern is removed.

11. A method of recording a magnetized pattern corresponding to an information signal array on a magnetic recording medium, the method comprising the steps of:
placing a master information carrier, made of a ferromagnetic thin-film patterned corresponding to an information signal array and formed on a non-magnetic substrate, opposing to a surface of the magnetic recording medium; and
heating the surface of the magnetic recording medium locally at a place opposing to a region between the ferromagnetic thin-films adjacent to each other via the master information carrier while a bias magnetic field is applied to the magnetic recording medium.

12. The recording method as defined in claim 11, wherein the non-magnetic substrate is translucent and the ferromagnetic thin-film is light-proof, wherein the local heating to the surface of the medium is carried out by irradiation of light energy transmitted through the region between the ferromagnetic thin-films adjacent to each other of the master information carrier.

13. The recording method as defined in claim 11, wherein the master information carrier includes a projection protruding from the region between the ferromagnetic thin-films adjacent to each other, wherein the local heating to the medium is carried out by conveying heat energy through the projection of the master information carrier.

14. The recording method as defined in claim 11,
wherein the region between the ferromagnetic thin-films is formed of non-magnetic solid body that generates heat by one of electric power and electromagnetic wave; and
wherein the local heating to the surface of the magnetic recording medium is carried out by conveying heat energy generated at the region.

15. The recording method as defined in claim 11, wherein the medium is DC-erased before placing the master information carrier opposing to the magnetic recording medium and is applied with the bias magnetic field having a reverse polarity to an initializing magnetization direction by the DC erasing.

16. The recording method as defined in claim 12, wherein the heating to the magnetic recording medium by light irradiation is carried out by irradiating an entire surface uniformly of the master information carrier with substantially parallel light.

17. The recording method as defined in claim 16, wherein a member for applying the bias magnetic field is disposed opposite to the master information carrier with respect to the magnetic recording medium.

18. The recording method as defined in claim 12, wherein the heating to the magnetic recording medium with light irradiation is carried out by scanning laser beam along a surface of the master information carrier.

19. The recording method as defined in claim 18, wherein a member for applying the bias magnetic field is disposed on an identical side to the master information carrier with respect to the magnetic recording medium.

20. The recording method as defined in claim 11,
wherein the information signal array has a recording wavelength “λ”, which changes depending on a place at the master information carrier; and
wherein a section corresponding to the region between the ferromagnetic thin-films adjacent to each other of the master information carrier is heated such that a section where the recording wavelength “λ” takes a longer value is heated to a higher temperature and a section where the recording wavelength “λ” takes a shorter value is heated to a lower temperature.

21. The recording method as defined in claim 11,
wherein the information signal array has a recording wavelength “λ”, and a distance between the magnetic recording medium and the opposing ferromagnetic thin-film of the master information carrier is “d₁”,
wherein the distance “d₁” is set based on the recording wavelength “λ” such that a relation of d₁<λ is satisfied.

22. The recording method as defined in claim 11,
wherein the information signal array has a recording wavelength “λ”, and a distance between the magnetic recording medium and the opposing ferromagnetic thin-film of the master information carrier is d₂,
wherein the distance d₂ is set based on the recording wavelength “λ” such that a relation of d₂≦0.1×λ is satisfied.

23. A method of manufacturing a magnetic recording medium, the method including a step of recording a magnetized pattern corresponding to an information signal array on the magnetic recording medium; the method comprising the steps of:
forming at least one magnetic recording layer and at least one protective layer on a plate;
forming a lubricating layer on the protective layer;
placing a master information carrier having a pattern corresponding to the information signal array and made of a ferromagnetic thin-film formed on a non-magnetic substrate such that the ferromagnetic thin-film confronts the magnetic recording layer;
applying a bias magnetic field at least to the magnetic recording layer formed on the plate and the ferromagnetic thin-film of the master information carrier while applying heat via the carrier locally to the magnetic recording layer formed on the plate at a section opposing to a region between the ferromagnetic thin-films adjacent to each other of the carrier for recording the magnetized pattern corresponding to the information signal array on the magnetic recording layer.

24. The manufacturing method as defined in claim 23, wherein the non-magnetic substrate is translucent, and the ferromagnetic thin-film is light-proof, wherein the local heating to the magnetic recording layer is carried out by irradiation of light energy transmitted through the region between the ferromagnetic thin-films adjacent to each other of the master information carrier.

25. The manufacturing method as defined in claim 23, wherein the master information carrier includes a projection protruding from the region between the ferromagnetic thin-films adjacent to each other, wherein the local heating to the magnetic recording layer is carried out by conveying heat energy through the projection of the master information carrier.

26. The manufacturing method as defined in claim 23,
wherein the information signal array has a recording wavelength “λ”, which changes depending on a place at the master information carrier; and
wherein a section of the magnetic recording layer corresponding to the region between the ferromagnetic thin-films adjacent to each other of the master information carrier is heated such that a section where the recording wavelength “λ” takes a longer value is heated to a higher temperature and a section where the recording wavelength “λ” takes a shorter value is heated to a lower temperature.

27. The manufacturing method as defined in claim 23,
wherein the information signal array has a recording wavelength “λ”, and a distance between the magnetic recording medium and the opposing ferromagnetic thin-film of the master information carrier is “d₁”,
wherein the distance “d₁” is set based on the recording wavelength “λ” such that a relation of d₁<λ is satisfied.

28. The manufacturing method as defined in claim 23,
wherein the information signal array has a recording wavelength “λ”, and a distance between the magnetic recording medium and the opposing ferromagnetic thin-film of the master information carrier is “d₂”,
wherein the distance “d₂” is set based on the recording wavelength “λ” such that a relation of d₂≦0.1×λ is satisfied.

29. A magnetic recording and reproducing apparatus comprising:
a thin-film magnetic head;
a magnetic recording medium of which surface is placed opposing to a master information carrier made of a ferromagnetic thin-film patterned corresponding to an information signal array and formed on a non-magnetic substrate, wherein a bias magnetic field is applied at least to the magnetic recording layer of the magnetic recording medium and the ferromagnetic thin-film of the master information carrier while heat is locally applied to the surface of the medium at a section opposing to a region between the ferromagnetic thin-films adjacent to each other of the carrier for recording the magnetized pattern corresponding to the information signal array onto the magnetic recording layer;
a supporting member for supporting the thin-film magnetic head such that the head opposes to the magnetic recording medium;
a rotating device for rotating the magnetic recording medium;
an actuating device coupled to the supporting member for moving the thin-film magnetic head along a film surface of the magnetic recording medium; and
a processing section coupled electrically to the thin-film magnetic head, the rotating device, and the actuating device, for exchanging a signal with the head, controlling the rotating of the medium, and controlling the moving of the head.

30. The magnetic recording and reproducing apparatus of claim 29, wherein the information signal is to be used for tracking servo.
